(19) United States
(12) Patent Application Publication
(10) Pub. No.: US 2025/0147578 A1
(43) Pub. Date: May 8, 2025

(54) Gaze Activation of Display Interface

(71) Applicant: Apple Inc., Cupertino, CA (US)

(72) Inventors: Thomas G. Salter, San Francisco, CA (US); Bart Trzynadlowski, Reno, NV (US); Bryce L. Schmidtchen, San Francisco, CA (US); Devin W. Chalmers, Oakland, CA (US); Gregory Lutter, Boulder Creek, CA (US)

(21) Appl. No.: 18/562,652

(22) PCT Filed: May 13, 2022
(86) PCT No.: PCT/US22/29176

§ 371 Date: Nov. 20, 2023

Related U.S. Application Data
(60) Provisional application No. 63/194,528, filed on May 28, 2021.

(51) Int. Cl. G06F 3/01

(52) U.S. Cl. CPC G06F 3/012; G06F 3/013; G06F 3/017

(57) ABSTRACT

Various implementations disclosed herein include devices, systems, and methods for using a gaze vector and head pose information to activate a display interface in an environment. In some implementations, a device includes a sensor for sensing a head pose of a user, a display, one or more processors, and a memory. In various implementations, a method includes displaying an environment comprising a field of view. Based on a gaze vector, it is determined that a gaze of the user is directed to a first location within the field of view. A head pose value corresponding to the head pose of the user is obtained. On a condition that the head pose value corresponds to a motion of the head of the user toward the first location, a user interface is displayed in the environment.

### CROSS-REFERENCE TO RELATED APPLICATION

This application claims the benefit of U.S. Provisional Patent App. No. 63/194,528, filed on May 28, 2021, which is incorporated by reference in its entirety.

### TECHNICAL FIELD

The present disclosure generally relates to interacting with computer-generated content.

### BACKGROUND

Some devices are capable of generating and presenting graphical environments that include many objects. These objects may mimic real world objects. These environments may be presented on mobile communication devices.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1G are diagrams of an example operating environment in accordance with some implementations.

FIG. 2 is a block diagram of a display interface engine in accordance with some implementations.

FIGS. 3A-3C are a flowchart representation of a method of using a gaze vector and head pose information to activate a heads up display (HUD) interface in an extended reality (XR) environment in accordance with some implementations.

FIG. 4 is a block diagram of a device that uses a gaze vector and head pose information to activate a HUD interface in an XR environment in accordance with some implementations.

FIGS. 5A-5H are diagrams of an example operating environment in accordance with some implementations.

FIG. 6 is a block diagram of a display interface engine in accordance with some implementations.

FIGS. 7A-7B are a flowchart representation of a method of using first and second user focus locations to activate a HUD interface in accordance with some implementations.

FIG. 8 is a block diagram of a device that uses first and second user focus locations to activate a HUD interface in accordance with some implementations.

FIG. 9 is a flowchart representation of a method of displaying a user interface based on gaze and head motion in accordance with some implementations.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### SUMMARY

Various implementations disclosed herein include devices, systems, and methods for using a gaze vector and head pose information to activate a heads up display (HUD) interface in an extended reality (XR) environment. In some implementations, a device includes a sensor for sensing a head pose of a user, a display, one or more processors, and a memory. In various implementations, a method includes displaying an XR environment comprising a field of view. Based on a gaze vector, it is determined that a gaze of the user is directed to a first location within the field of view. A head pose value corresponding to the head pose of the user is obtained. On a condition that the head pose value corresponds to a motion of the head of the user toward the first location, a user interface is displayed in the XR environment.

In various implementations, a method includes obtaining a first user input corresponding to a first user focus location. It is determined that the first user focus location corresponds to a first location within a field of view. A second user input corresponding to a second user focus location is obtained. On a condition that the second user focus location corresponds to a second location different from the first location within the field of view, a first user interface is displayed.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

Implementations described herein contemplate the use of gaze information to determine virtual objects at which a user's attention is focused. Implementers should consider the extent to which gaze information is collected, analyzed, disclosed, transferred, and/or stored, such that well-established privacy policies and/or privacy practices are respected. These considerations should include the application of practices that are generally recognized as meeting or exceeding industry requirements and/or governmental requirements for maintaining the user privacy. The present disclosure also contemplates that the use of a user's gaze information may be limited to what is necessary to implement the described embodiments. For instance, in implementations where a user's device provides processing power, the gaze information may be processed at the user's device, locally.

Some devices display an extended reality (XR) environment that includes one or more objects, e.g., virtual objects. A user may select or otherwise interact with the objects through a variety of modalities. For example, some devices allow a user to select or otherwise interact with objects using a gaze input. A gaze-tracking device, such as a user-facing image sensor, may obtain an image of the user's pupils. The image may be used to determine a gaze vector. The gaze-tracking device may use the gaze vector to determine which object the user intends to select or interact with.

When using a gaze-tracking device, a user may find it beneficial to have convenient access to certain user interface elements, such as widgets, information elements, and/or shortcuts to frequently accessed applications. The gaze-tracking device may present an interface, including, but not limited to, a heads up display (HUD) interface that incorporates one or more user interface elements. A user may unintentionally trigger activation of the HUD interface. For example, the gaze-tracking device may register a false positive input, e.g., a registered user activation of the HUD interface when the user did not actually intend to activate the HUD interface. When this occurs, the user may expend effort (e.g., additional user inputs) to dismiss the HUD interface. Additionally, the user may unintentionally interact with elements of the HUD interface. For example, the user may unintentionally activate controls that form part of the HUD interface. These unintentional interactions may degrade the user experience. Power consumption may be adversely affected by the additional inputs involved in correcting false positives.

The present disclosure provides methods, systems, and/or devices for using a combination of a gaze vector and head pose information to activate a HUD interface in an XR environment. In some implementations, a device displays a HUD interface when a user gazes in a particular direction (e.g., up or to an upper left corner of the field of view) and performs a head motion in the same direction as the gaze. The device may train the user to perform this combination of a gaze and a head motion by displaying an affordance (e.g., a red dot) that prompts the user to look at the affordance and then instructing the user to perform a head motion (e.g., a nod). In some implementations, the device may forgo displaying the affordance. For example, as the user becomes more familiar with the technique, the affordance may be gradually phased out and, eventually, omitted.

In some implementations, using the combination of the gaze vector and the head pose information to activate the HUD interface improves the user experience, e.g., by reducing inadvertent activations of the HUD interface. The number of user inputs that are provided by the user may be reduced, for example, by reducing the number of inputs that are needed to correct for false positives. Battery life may be enhanced as a result.

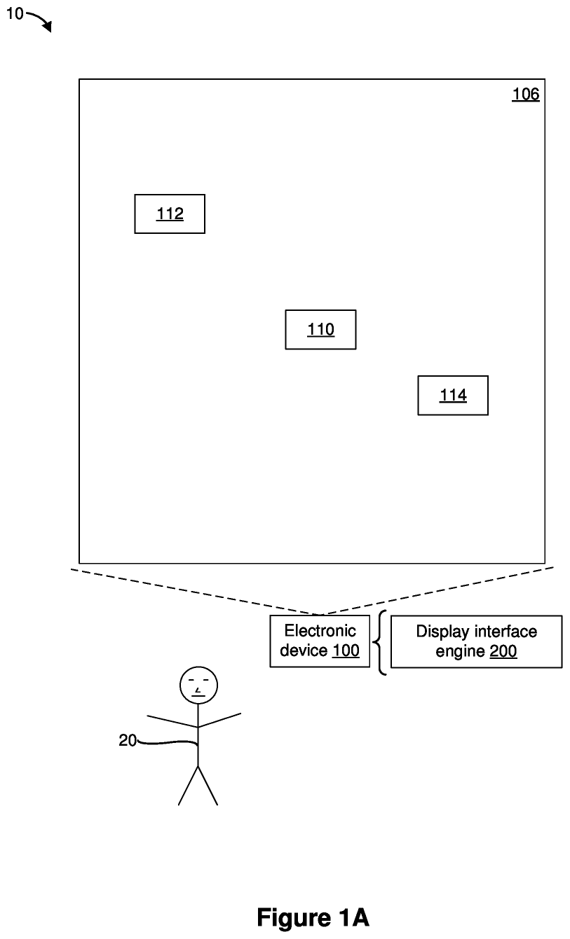

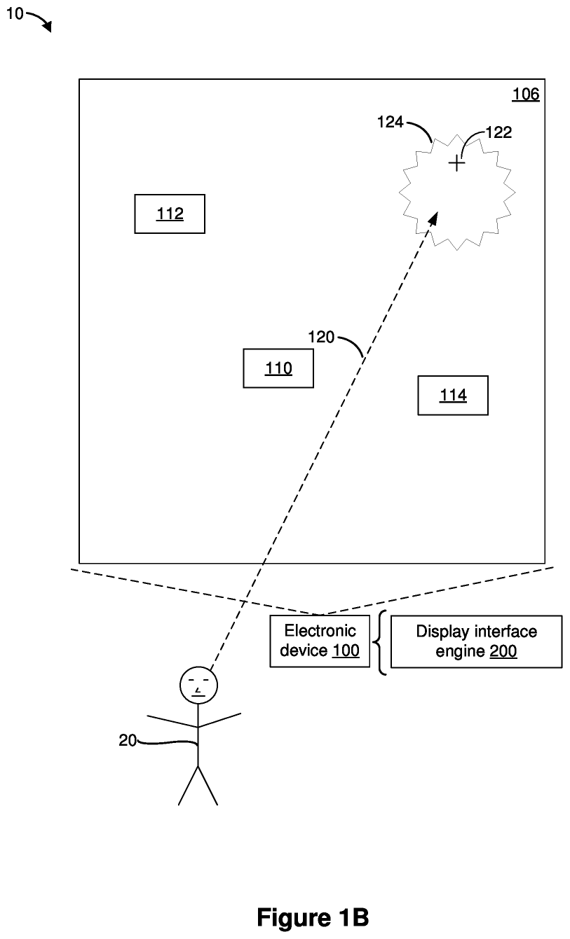

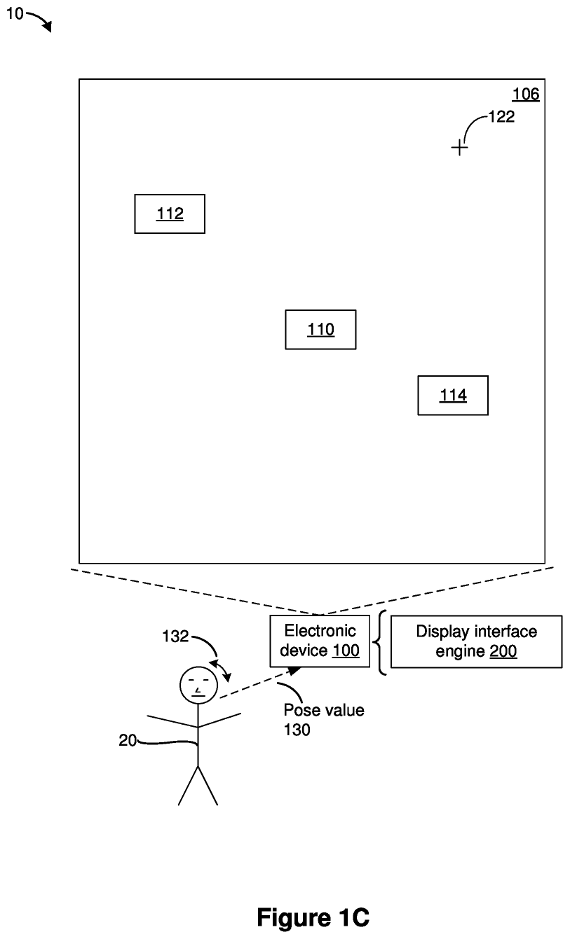

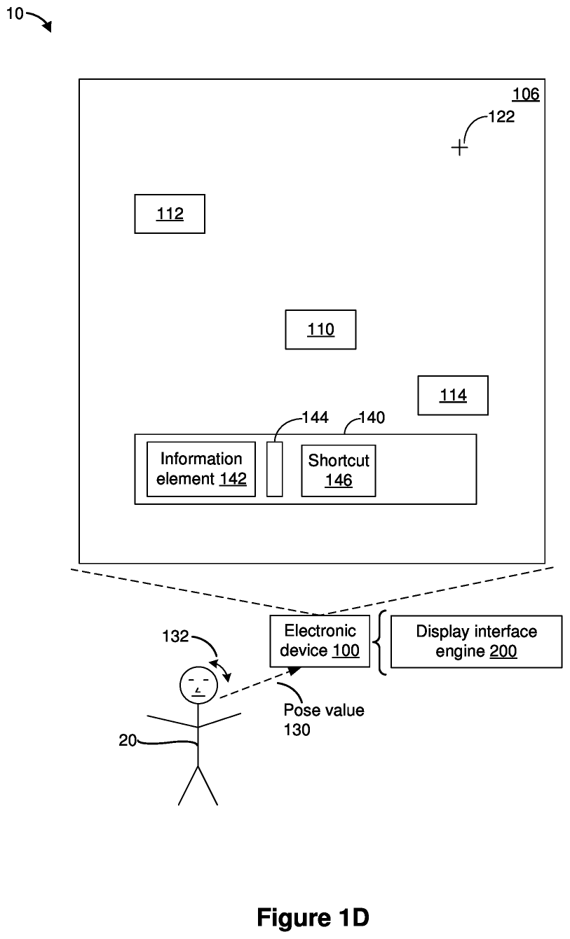

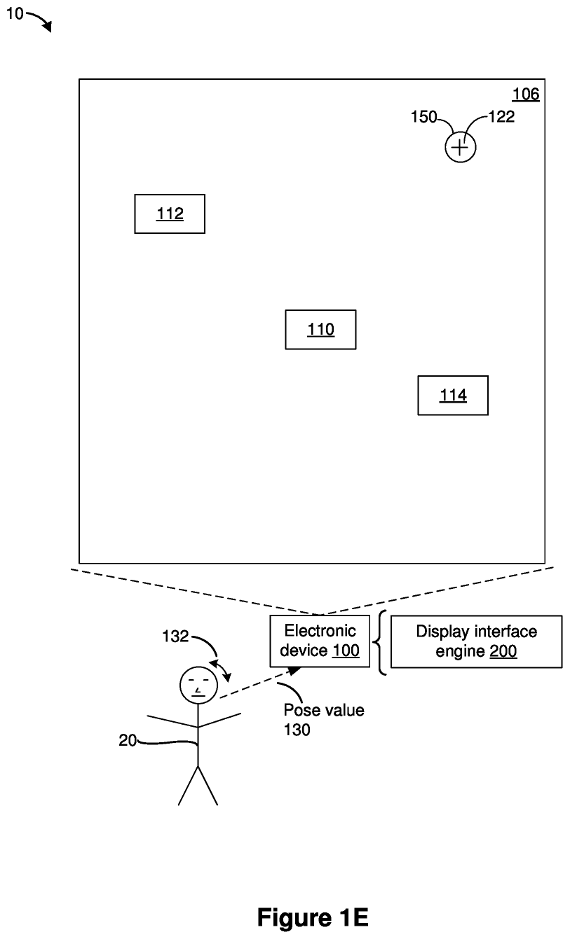

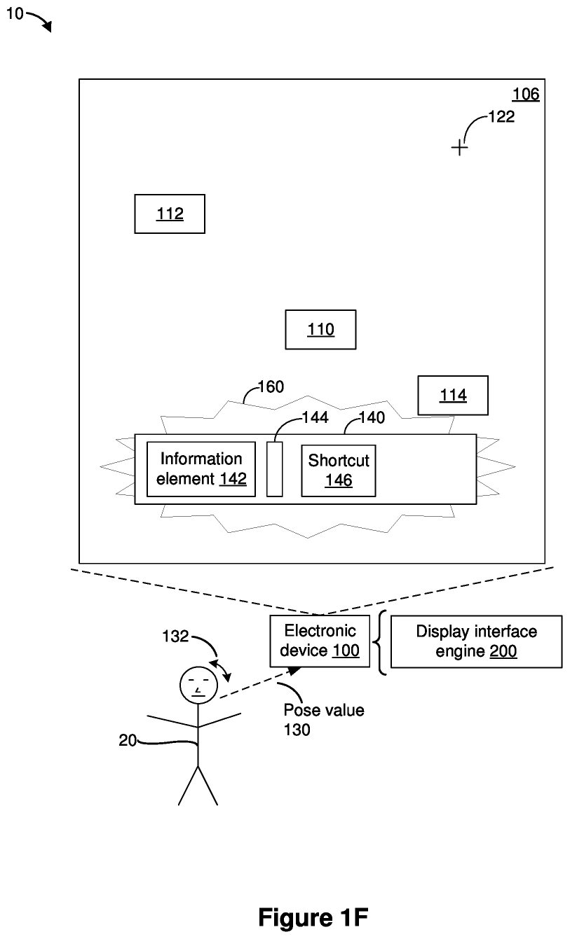

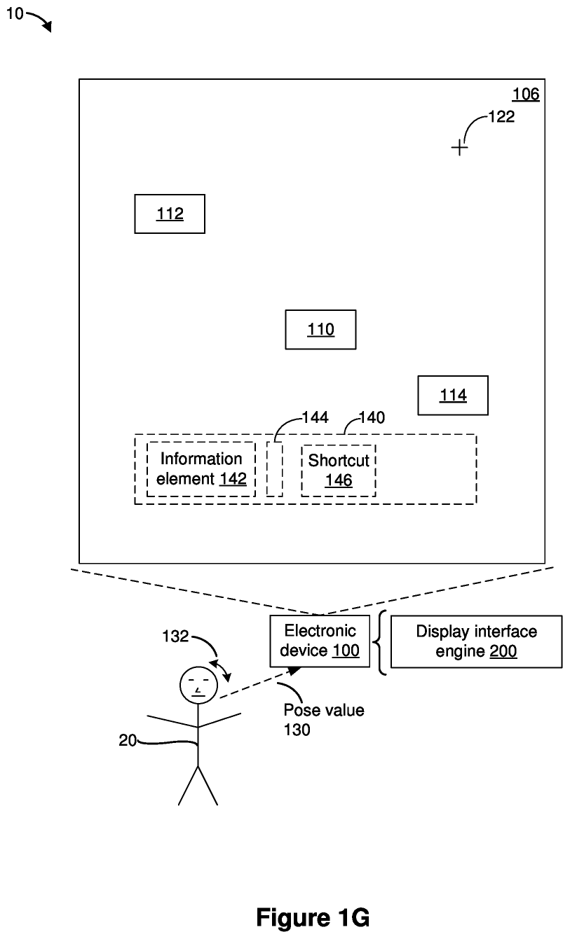

FIG. 1A is a block diagram of an example operating environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 10 includes an electronic device 100 and a display interface engine 200. In some implementations, the electronic device 100 includes a handheld computing device that can be held by a user 20. For example, in some implementations, the electronic device 100 includes a smartphone, a tablet, a media player, a laptop, or the like. In some implementations, the electronic device 100 includes a wearable computing device that can be worn by the user 20. For example, in some implementations, the electronic device 100 includes a head-mountable device (HMD) or an electronic watch.

In the example of FIG. 1A, the display interface engine 200 resides at the electronic device 100. For example, the electronic device 100 implements the display interface engine 200. In some implementations, the electronic device 100 includes a set of computer-readable instructions corresponding to the display interface engine 200. Although the display interface engine 200 is shown as being integrated into the electronic device 100, in some implementations, the display interface engine 200 is separate from the electronic device 100. For example, in some implementations, the display interface engine 200 resides at another device (e.g., at a controller, a server or a cloud computing platform).

As illustrated in FIG. 1A, in some implementations, the electronic device 100 presents an extended reality (XR) environment 106 that includes a field of view of the user 20. In some implementations, the XR environment 106 is referred to as a computer graphics environment. In some implementations, the XR environment 106 is referred to as a graphical environment. In some implementations, the electronic device 100 generates the XR environment 106. Alternatively, in some implementations, the electronic device 100 receives the XR environment 106 from another device that generated the XR environment 106.

In some implementations, the XR environment 106 includes a virtual environment that is a simulated replacement of a physical environment. In some implementations, the XR environment 106 is synthesized by the electronic device 100. In such implementations, the XR environment 106 is different from a physical environment in which the electronic device 100 is located. In some implementations, the XR environment 106 includes an augmented environment that is a modified version of a physical environment. For example, in some implementations, the electronic device 100 modifies (e.g., augments) the physical environment in which the electronic device 100 is located to generate the XR environment 106. In some implementations, the electronic device 100 generates the XR environment 106 by simulating a replica of the physical environment in which the electronic device 100 is located. In some implementations, the electronic device 100 generates the XR environment 106 by removing and/or adding items from the simulated replica of the physical environment in which the electronic device 100 is located.

In some implementations, the XR environment 106 includes various virtual objects such as an XR object 110 (“object 110”, hereinafter for the sake of brevity). In some implementations, the XR environment 106 includes multiple objects. In the example of FIG. 1A, the XR environment 106 includes objects 110, 112, and 114. In some implementations, the virtual objects are referred to as graphical objects or XR objects. In various implementations, the electronic device 100 obtains the virtual objects from an object datastore (not shown). For example, in some implementations, the electronic device 100 retrieves the object 110 from the object datastore. In some implementations, the virtual objects represent physical articles. For example, in some implementations, the virtual objects represent equipment (e.g., machinery such as planes, tanks, robots, motorcycles, etc.). In some implementations, the virtual objects represent fictional elements (e.g., entities from fictional materials, for example, an action figure or a fictional equipment such as a flying motorcycle).

In various implementations, as represented in FIG. 1B, the electronic device 100 (e.g., the display interface engine 200) determines a gaze vector 120. For example, the electronic device 100 may include a user-facing image sensor (e.g., a front-facing camera or an inward-facing camera). In some implementations, the user-facing image sensor captures a set of one or more images of the eyes of the user 20. The electronic device 100 may determine the gaze vector 120 based on the set of one or more images. Based on the gaze vector 120, the electronic device 100 may determine that a gaze of the user 20 is directed to a particular location 122 in the XR environment 106. In some implementations, the electronic device 100 may display a visual effect 124 in connection with the location 122. For example, the electronic device 100 may display an area of increased brightness around the location 122. As another example, the electronic device 100 may display a pointer at or near the location 122.

In some implementations, as represented in FIG. 1C, the electronic device 100 (e.g., the display interface engine 200) obtains a head pose value 130 that corresponds to a head pose 132 of the user 20. For example, the electronic device 100 may include one or more sensors that are configured to sense the position and/or motion of the head of the user 20. The one or more sensors may include, for example, an image sensor, an accelerometer, a gyroscope, a magnetometer, and/or an inertial measurement unit (IMU).

In some implementations, as represented by FIG. 1D, the electronic device 100 displays a user interface 140 in the XR environment 106 on a condition that the head pose value 130 corresponds to a motion of the head of the user 20 toward the location 122. For example, if the location 122 is in the upper right corner of the field of view of the user 20, the electronic device 100 may display the user interface 140 if the head pose value 130 corresponds to a motion of the head of the user 20 in a direction that includes an upward tilt and a rotation or translation to the right. In some implementations, the electronic device 100 displays the user interface 140 in response to the head pose value 130 corresponding to a predefined head motion (e.g., a nod) while the gaze vector 120 indicates that a gaze of the user 20 is directed to the location 122. As such, in some implementations, the user 20 can trigger display of the user interface 140 by concurrently gazing at the location 122 and performing a nod. In some implementations, if the user 20 gazes at the location 122 and does not perform the nod, the electronic device 100 does not display the user interface 140.

In some implementations, the user interface 140 is displayed proximate the location 122 and includes one or more user interface elements. For example, the user interface 140 may include an information element 142 that displays information, e.g., from an application executing on the electronic device 100 and/or on another device. In some implementations, the user interface 140 includes an affordance 144. The user 20 may provide an input to the affordance 144 and control an application executing on the electronic device 100 and/or on another device. In some implementations, the user interface 140 includes a shortcut 146. The user 20 may provide an input to the shortcut 146 and open an application executing on the electronic device 100 and/or on another device and/or may access a content item stored on the electronic device 100 and/or on another device.

In some implementations, as represented in FIG. 1E, the electronic device 100 displays an affordance 150 at the location 122. The affordance 150 may be used to train the user 20 to make the head motion to produce the head pose value that causes the user interface 140 to be displayed in the XR environment 106. In some implementations, the electronic device 100 displays the affordance 150 in the XR environment 106. The affordance 150 may be obscured (e.g., cease to be displayed) after a condition is satisfied. For example, the electronic device 100 may obscure the affordance 150 after the user interface 140 has been displayed in the XR environment 106 for a threshold duration. In some implementations, the electronic device 100 obscures the affordance 150 after the user interface 140 has been displayed in the XR environment 106 at least a threshold number of times. In some implementations, the electronic device 100 obscures (e.g., ceases to display) the affordance 150 in response to detecting a user input directed to the affordance 150. For example, the affordance 150 may be obscured (e.g., ceased to be displayed) in the XR environment 106 when the user 20 gestures toward the affordance 150 or makes a head motion toward the affordance 150. In some implementations, the electronic device 100 forgoes display of the affordance 150 in response to determining that a user interface activation score is greater than a threshold activation score (e.g., an activation rate of the user interface 140 is greater than a threshold activation rate) indicating that the user has become accustomed to using a combination of a gaze input and a head motion to activate display of the user interface 140.

In some implementations, as represented in FIG. 1F, the electronic device 100 changes one or more visual properties of the user interface 140. The electronic device 100 may change the one or more visual properties of the user interface 140, for example, to enhance visibility of the user interface 140. In some implementations, the electronic device 100 displays a visual effect 160 in connection with the user interface 140. For example, the electronic device 100 may change the brightness of the user interface 140. In some implementations, the electronic device 100 changes the contrast between the user interface 140 and the XR environment 106, e.g., a passthrough portion of the XR environment 106. In some implementations, the electronic device 100 changes a color of the user interface 140, e.g., to enhance the visibility of the user interface 140. In some implementations, the electronic device 100 changes a size of the user interface 140. For example, the electronic device 100 may display the user interface 140 in a larger size. In some implementations, the electronic device 100 displays an animation in connection with the user interface 140.

In some implementations, as represented in FIG. 1G, the electronic device 100 obscures the user interface 140, e.g., after a dismissal condition has occurred. For example, the electronic device 100 may remove (e.g., cease to display) the user interface 140 from the XR environment 106 after a threshold duration has elapsed after a user input directed to the user interface 140 has been detected. In some implementations, the electronic device 100 may remove the user interface 140 from the XR environment 106 after the user interface 140 has been displayed for a threshold duration. In some implementations, the electronic device 100 may remove the user interface 140 from the XR environment 106 in response to detecting a particular user input, e.g., directed to the user interface 140. For example, the user may perform a specified gesture (e.g., a motion of an extremity or a head) to cause the user interface 140 to be dismissed.

In some implementations, the user interface 140 is obscured by removing the user interface 140 from the XR environment 106. The user interface 140 may be obscured by changing one or more visual properties of the user interface 140 to make the user interface 140 less prominent in the XR environment 106. For example, the electronic device 100 may decrease the brightness of the user interface 140. As another example, the electronic device 100 may increase the transparency of the user interface 140. In some implementations, the electronic device 100 decreases the contrast between the user interface 140 and the XR environment 106, e.g., a passthrough portion of the XR environment 106. In some implementations, the electronic device 100 changes a color of the user interface 140, e.g., to reduce the visibility of the user interface 140. In some implementations, the electronic device 100 changes a size of the user interface 140. For example, the electronic device 100 may display the user interface 140 in a smaller size.

In some implementations, the electronic device 100 includes or is attached to a head-mountable device (HMD) worn by the user 20. The HMD presents (e.g., displays) the XR environment 106 according to various implementations. In some implementations, the HMD includes an integrated display (e.g., a built-in display) that displays the XR environment 106. In some implementations, the HMD includes a head-mountable enclosure. In various implementations, the head-mountable enclosure includes an attachment region to which another device with a display can be attached. For example, in some implementations, the electronic device 100 can be attached to the head-mountable enclosure. In various implementations, the head-mountable enclosure is shaped to form a receptacle for receiving another device that includes a display (e.g., the electronic device 100). For example, in some implementations, the electronic device 100 slides/snaps into or otherwise attaches to the head-mountable enclosure. In some implementations, the display of the device attached to the head-mountable enclosure presents (e.g., displays) the XR environment 106. In various implementations, examples of the electronic device 100 include smartphones, tablets, media players, laptops, etc.

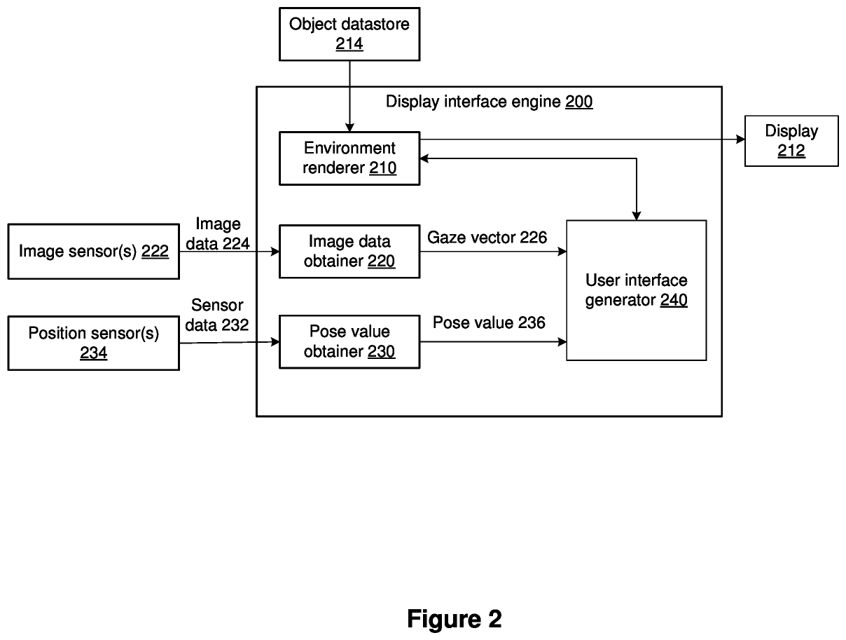

FIG. 2 illustrates a block diagram of the display interface engine 200 in accordance with some implementations. In some implementations, the display interface engine 200 includes an environment renderer 210, an image data obtainer 220, a head pose value obtainer 230, and a user interface generator 240. In various implementations, the environment renderer 210 displays an extended reality (XR) environment that includes a set of virtual objects in a field of view. For example, with reference to FIG. 1A, the environment renderer 210 may display the XR environment 106, including virtual objects 110, 112, and 114, on a display 212. In various implementations, the environment renderer 210 obtains the virtual objects from an object datastore 214. The virtual objects may represent physical articles. For example, in some implementations, the virtual objects represent equipment (e.g., machinery such as planes, tanks, robots, motorcycles, etc.). In some implementations, the virtual objects represent fictional elements.

In some implementations, the image data obtainer 220 obtains sensor data from one or more image sensor(s) 222 that capture one or more images of a user, e.g., the user 20 of FIG. 1A. For example, a user-facing image sensor (e.g., a front-facing camera or an inward-facing camera) may capture a set of one or more images of the eyes of the user 20 and may generate image data 224. The image data obtainer 220 may obtain the image data 224. In some implementations, the image data obtainer 220 determines a gaze vector 226 based on the image data 224. The display interface engine 200 may determine, based on the gaze vector 226, that the gaze of the user 20 is directed to a location within the field of view.

In some implementations, the head pose value obtainer 230 obtains head sensor data 232 from one or more head position sensor(s) 234 that sense the position and/or motion of the head of the user 20. The one or more head position sensor(s) 234 may include, for example, an image sensor, an accelerometer, a gyroscope, a magnetometer, and/or an inertial measurement unit (IMU). The head pose value obtainer 230 may generate a head pose value 236 based on the head sensor data 232.

In some implementations, the user interface generator 240 causes a user interface to be displayed in the XR environment 106 on a condition that the head pose value 236 corresponds to a motion of the head of the user 20 toward the location to which the gaze of the user 20 is directed. For example, if the location is in the upper right corner of the field of view of the user 20, the user interface generator 240 may generate a user interface and insert the user interface into the XR environment 106 to be rendered by the environment renderer 210 if the head pose value 236 corresponds to a motion of the head of the user 20 in a direction that includes an upward tilt and a rotation or translation to the right. In some implementations, the user interface generator 240 modifies the XR environment 106 to generate a modified XR environment that includes a representation of the user interface. In some implementations, the user interface generator 240 triggers display of the user interface in response to concurrently detecting a head pose value 236 that corresponds to a threshold head motion (e.g., a nod) and a gaze vector 226 that indicates that a gaze of the user is directed to a particular location (e.g., a location associated with the user interface). In some implementations, if the gaze vector 226 indicates that the gaze of the user is directed to the particular location associated with the user interface but the head pose value 236 does not correspond to the threshold head motion (e.g., the user is gazing at the upper right corner but not nodding), the user interface generator 240 does not trigger display of the user interface. Similarly, in some implementations, if the gaze vector 226 indicates that the gaze of the user is not directed to the particular location associated with the user interface but the head pose value 236 corresponds to the threshold head motion (e.g., the user is not gazing at the upper right corner but the user is nodding), the user interface generator 240 does not trigger display of the user interface.

In some implementations, the environment renderer 210 and/or the user interface generator 240 displays an affordance to train the user to make the head motion to produce the head pose value that causes the user interface to be displayed in the XR environment 106. For example, the affordance may be displayed when the image data obtainer 220 determines that the gaze vector 226 is directed to a particular location in the XR environment 106. The affordance may prompt the user 20 to produce a head motion toward the affordance. In some implementations, the affordance is obscured (e.g., display of the affordance is ceased) after a condition is satisfied. For example, the affordance may be obscured after the user interface has been displayed in the XR environment 106 for a threshold duration. In some implementations, the affordance is obscured after the user interface has been displayed in the XR environment 106 at least a threshold number of times. In some implementations, the affordance is obscured in response to detecting a user input (e.g., a gesture or a head motion) directed to the affordance.

In some implementations, the user interface generator 240 enhances the visibility of the user interface by changing one or more visual properties of the user interface. For example, the user interface generator 240 may change the brightness of the user interface. In some implementations, the user interface generator 240 changes the contrast between the user interface and the XR environment 106, e.g., a passthrough portion of the XR environment 106. In some implementations, the user interface generator 240 changes a color of the user interface. In some implementations, the user interface generator 240 increases a size of the user interface.

In some implementations, the user interface generator 240 removes or reduces the visibility of the user interface, e.g., after a dismissal condition has occurred. For example, the user interface generator 240 may remove the user interface from the XR environment 106 after a threshold duration has elapsed after a user input directed to the user interface has been detected. In some implementations, the user interface generator 240 removes the user interface from the XR environment 106 after the user interface has been displayed for a threshold duration. In some implementations, the user interface generator 240 removes the user interface from the XR environment 106 in response to detecting a particular user input, e.g., directed to the user interface. For example, the user may perform a specified gesture (e.g., a motion of an extremity or a head) to cause the user interface to be dismissed.

The visibility of the user interface may be reduced by changing one or more visual properties of the user interface. For example, the user interface generator 240 may decrease the brightness of the user interface. As another example, the user interface generator 240 may increase the transparency of the user interface. In some implementations, the user interface generator 240 decreases the contrast between the user interface and the XR environment 106, e.g., a passthrough portion of the XR environment 106. In some implementations, the user interface generator 240 changes a color of the user interface. In some implementations, the user interface generator 240 reduces a size of the user interface.

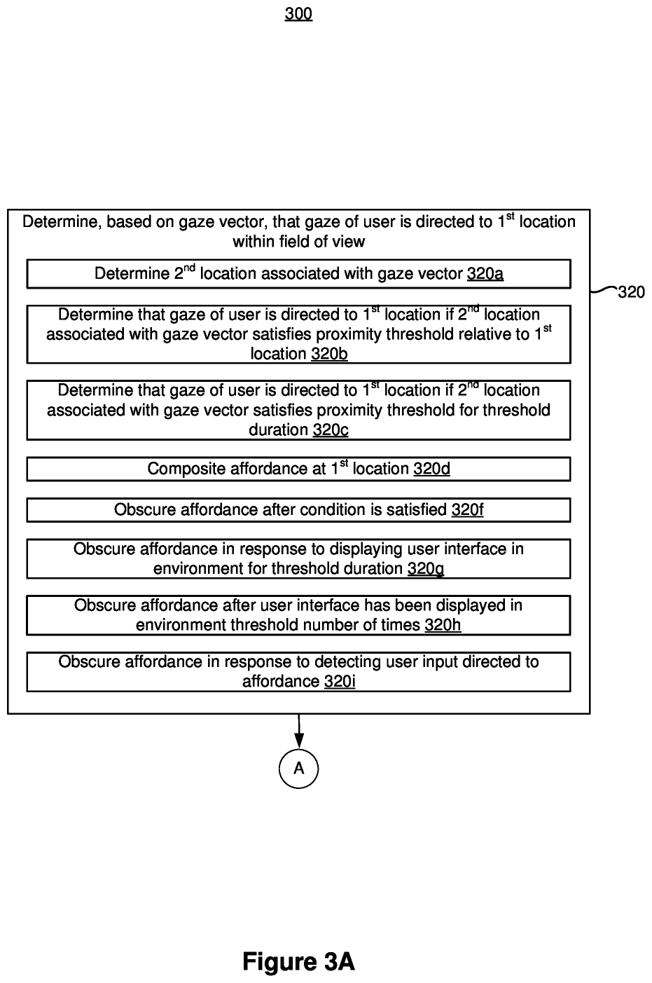

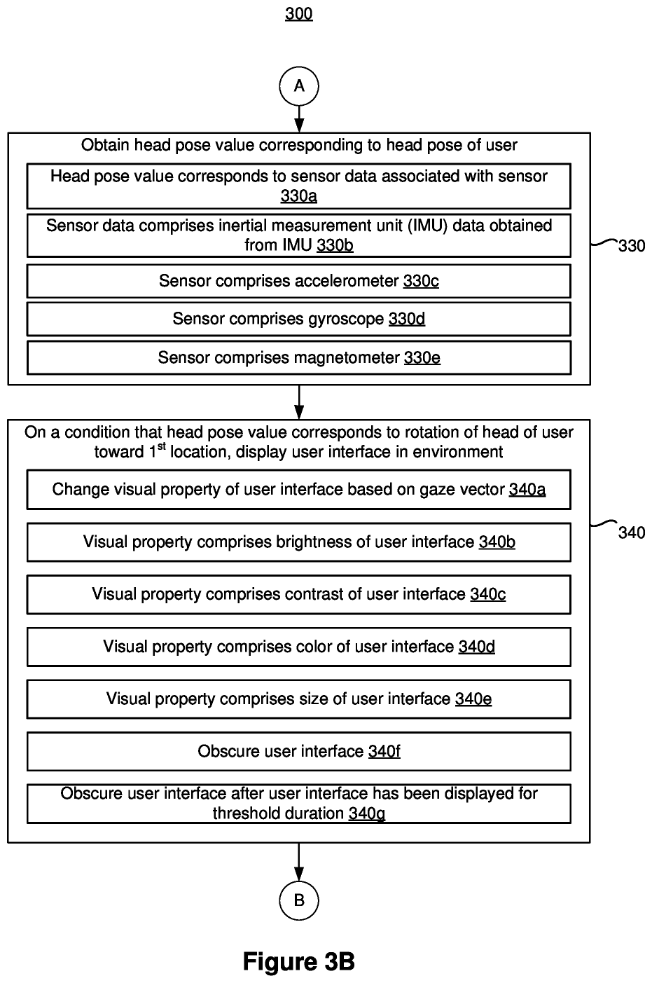

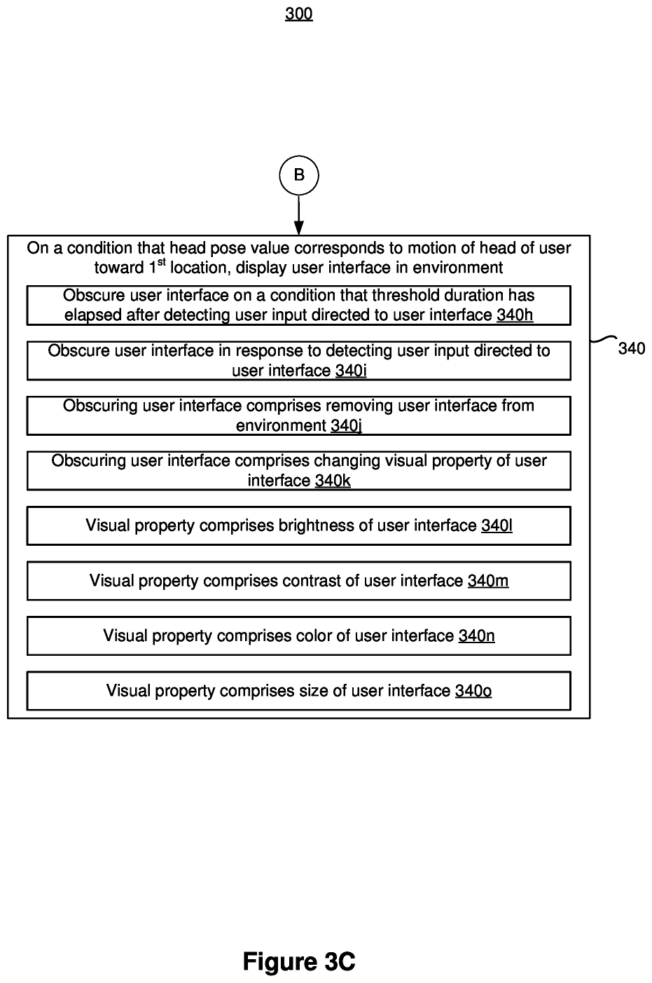

FIGS. 3A-3C are a flowchart representation of a method 300 for using a gaze vector and head pose information to activate a heads up display (HUD) interface in an extended reality (XR) environment. In various implementations, the method 300 is performed by a device (e.g., the electronic device 100 shown in FIGS. 1A-1G, or the display interface engine 200 shown in FIGS. 1A-1G and 2). In some implementations, the method 300 is performed by processing logic, including hardware, firmware, software, or a combination thereof. In some implementations, the method 300 is performed by a processor executing code stored in a non-transitory computer-readable medium (e.g., a memory).

In various implementations, an XR environment comprising a field of view is displayed. In some implementations, the XR environment is generated. In some implementations, the XR environment is received from another device that generated the XR environment.

The XR environment may include a virtual environment that is a simulated replacement of a physical environment. In some implementations, the XR environment is synthesized and is different from a physical environment in which the electronic device is located. In some implementations, the XR environment includes an augmented environment that is a modified version of a physical environment. For example, in some implementations, the electronic device modifies the physical environment in which the electronic device is located to generate the XR environment. In some implementations, the electronic device generates the XR environment by simulating a replica of the physical environment in which the electronic device is located. In some implementations, the electronic device removes and/or adds items from the simulated replica of the physical environment in which the electronic device is located to generate the XR environment.

In some implementations, the electronic device includes a head-mountable device (HMD). The HMD may include an integrated display (e.g., a built-in display) that displays the XR environment. In some implementations, the HMD includes a head-mountable enclosure. In various implementations, the head-mountable enclosure includes an attachment region to which another device with a display can be attached. In various implementations, the head-mountable enclosure is shaped to form a receptacle for receiving another device that includes a display. In some implementations, the display of the device attached to the head-mountable enclosure presents (e.g., displays) the XR environment. In various implementations, examples of the electronic device include smartphones, tablets, media players, laptops, etc.

In various implementations, as represented by block 320, the method 300 includes determining, based on a gaze vector, that a gaze of the user is directed to a first location within the field of view. For example, in some implementations, a user-facing image sensor, such as a front-facing camera or an inward-facing camera, is used to capture a set of one or more images of the eyes of the user. The gaze vector may be determined based on the set of one or more images. In some implementations, as represented by block 320a, the method 300 includes determining a second location associated with the gaze vector. For example, the electronic device may determine a location in the XR environment to which the gaze vector is directed.

In some implementations, the electronic device determines that the gaze vector is directed to a particular location, such as a corner of the field of view. For example, as represented by block 320b, the method 300 may include determining that the gaze of the user is directed to the first location on a condition that the second location associated with the gaze vector satisfies a proximity criterion relative to the first location. In some implementations, as represented by block 320c, the method 300 may include determining that the gaze of the user is directed to the first location on a condition that the second location associated with the gaze vector satisfies the proximity criterion for a threshold duration. For example, the electronic device may forego determining that the gaze of the user is directed to the first location if the gaze vector is directed to a second location near the first location for a time duration that is less than a threshold time duration, e.g., the user merely glances toward the first location.

In some implementations, as represented by block 320d, the electronic device displays an affordance (e.g., a dot) proximate the first location. The affordance may elicit the head motion corresponding to the head pose value that causes the user interface to be displayed in the XR environment. For example, the affordance may be displayed as a target, e.g., a dot in the XR environment. In some implementations, as represented by block 320f, the method includes ceasing displaying the affordance after a condition is satisfied. For example, the electronic device may cease displaying the affordance after the user interface has been displayed for a threshold duration, as represented by block 320g. In some implementations, as represented by block 320h, the electronic device ceases displaying the affordance after the user interface has been displayed a threshold number of times. In some implementations, as represented by block 320i, the electronic device ceases displaying the affordance in response to detecting a user input directed to the affordance, such as a gesture or a head motion.

In various implementations, as represented by block 330 of FIG. 3B, the method 300 includes obtaining a head pose value corresponding to a head pose of the user. In some implementations, as represented by block 330a, the head pose value corresponds to sensor data that is associated with the sensor. For example, the electronic device may include one or more sensors that are configured to sense the position and/or motion of the head of the user. In some implementations, as represented by block 330b, the sensor data includes inertial measurement unit (IMU) data that is obtained from an IMU. As represented by block 330c, in some implementations, the sensor includes an accelerometer. In some implementations, as represented by block 330d, the sensor includes a gyroscope. As represented by block 330e, in some implementations, the sensor includes a magnetometer.

In various implementations, as represented by block 340, the method 300 includes displaying a user interface in the XR environment on a condition that the head pose value corresponds to a rotation of the head of the user toward the first location. For example, if the first location is the upper right corner of the field of view, the electronic device displays the user interface if the gaze of the user is directed to the upper right corner of the field of view and the user performs a head rotation toward the upper right corner of the field of view. In some implementations, the condition is a rotation of a head-forward vector toward the first location. In some implementations, the head-forward vector indicates a direction in which the head of the user is facing. In some implementations, using the combination of the gaze vector and the head pose information to activate the HUD interface improves the user experience, e.g., by reducing inadvertent activations of the HUD interface. The number of user inputs that are provided by the user may be reduced, for example, by reducing the number of inputs that are needed to correct for false positives. Battery life may be enhanced as a result.

In some implementations, a visual property of the user interface is changed to enhance or reduce the visibility of the user interface. For example, as represented by block 340a, a visual property of the user interface may be changed based on the gaze vector. This may be done to cause the user interface to be displayed more prominently when the user looks at the user interface. In some implementations, as represented by block 340b, the visual property comprises a brightness of the user interface. In some implementations, as represented by block 340c, the visual property comprises a contrast of the user interface, e.g., with reference to a passthrough portion of the XR environment. In some implementations, as represented by block 340d, the visual property comprises a color of the user interface. For example, the color of the user interface may be changed to enhance the visibility of the user interface. In some implementations, as represented by block 340e, the visual property comprises a size of the user interface. For example, the electronic device may display the user interface in a larger size.

In some implementations, as represented by block 340f, the electronic device obscures the user interface. For example, as represented by block 340g, the electronic device may obscure the user interface after the user interface has been displayed for a threshold duration. For example, as represented by block 340h of FIG. 3C, the electronic device may obscure the user interface on a condition that a threshold duration has elapsed after a user input directed to the user interface has been detected. In some implementations, as represented by block 340i, the electronic device obscures the user interface in response to detecting a user input directed to the user interface. For example, the user may perform a specified gesture (e.g., a motion of an extremity or a head) to cause the user interface to be dismissed.

In some implementations, as represented by block 340j, the user interface is obscured by ceasing to display the user interface. For example, the user interface generator 240 may modify the XR environment such that the XR environment no longer includes a representation of the user interface. The environment renderer 210 may display the XR environment without the user interface.

As represented by block 340k, the user interface may be obscured by changing a visual property of the user interface, e.g., to make the user interface less prominent in the XR environment. In some implementations, as represented by block 340l, the visual property comprises a brightness of the user interface. For example, the electronic device may decrease the brightness of the user interface. In some implementations, as represented by block 340m, the visual property comprises a contrast of the user interface, e.g., with reference to a passthrough portion of the XR environment. In some implementations, as represented by block 340n, the visual property comprises a color of the user interface. For example, the electronic device 100 may display the user interface 140 in a smaller size.

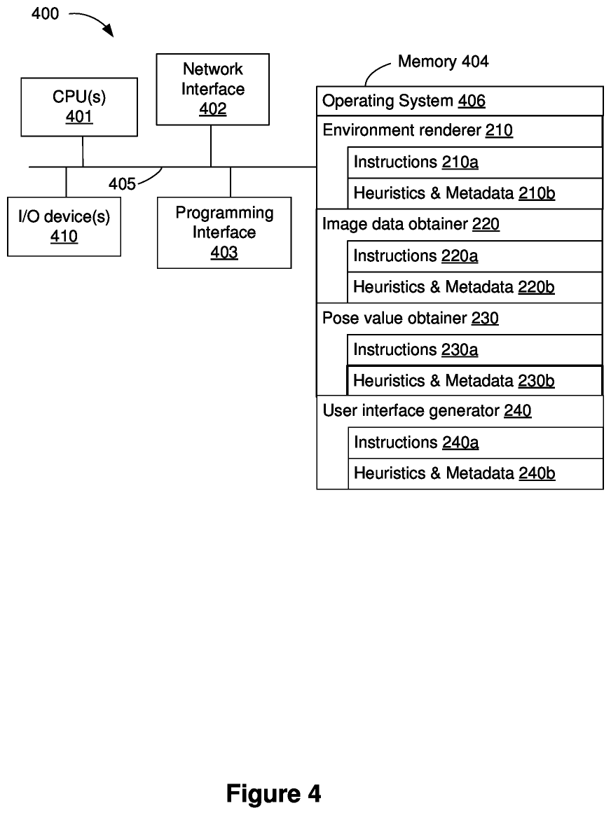

FIG. 4 is a block diagram of a device 400 in accordance with some implementations. In some implementations, the device 400 implements the electronic device 100 shown in FIGS. 1A-1G, and/or the display interface engine 200 shown in FIGS. 1A-1G and 2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (CPUs) 401, a network interface 402, a programming interface 403, a memory 404, one or more input/output (I/O) devices 410, and one or more communication buses 405 for interconnecting these and various other components.

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more CPUs 401. The memory 404 comprises a non-transitory computer readable storage medium.

In some implementations, the memory 404 or the non-transitory computer readable storage medium of the memory 404 stores the following programs, modules and data structures, or a subset thereof including an optional operating system 406, the environment renderer 210, the image data obtainer 220, the head pose value obtainer 230, and the user interface generator 240. In various implementations, the device 400 performs the method 300 shown in FIGS. 3A-3C.

In some implementations, the environment renderer 210 displays an extended reality (XR) environment that includes a set of virtual objects in a field of view. In some implementations, the environment renderer 210 includes instructions 210a and heuristics and metadata 210b.

In some implementations, the image data obtainer 220 obtains sensor data from one or more image sensors that capture one or more images of a user, e.g., the user 20 of FIG. 1A. In some implementations, the image data obtainer 220 determines a gaze vector. In some implementations, the image data obtainer 220 performs the operation(s) represented by block 320 in FIGS. 3A-3C. To that end, the image data obtainer 220 includes instructions 220a and heuristics and metadata 220b.

In some implementations, the head pose value obtainer 230 obtains head sensor data from one or more head position sensors that sense the position and/or motion of the head of the user 20. The one or more head position sensors may include, for example, an accelerometer, a gyroscope, a magnetometer, and/or an inertial measurement unit (IMU). The head pose value obtainer 230 may generate a head pose value based on the head sensor data. In some implementations, the head pose value obtainer 230 performs the operations represented by block 330 in FIGS. 3A-3C. To that end, the head pose value obtainer 230 includes instructions 230a and heuristics and metadata 230b.

In some implementations, the user interface generator 240 causes a user interface to be displayed in the XR environment on a condition that the head pose value corresponds to a motion of the head of the user 20 toward the location to which the gaze of the user 20 is directed. In some implementations, the user interface generator 240 performs the operations represented by block 340 in FIGS. 3A-3C. To that end, the user interface generator 240 includes instructions 240a and heuristics and metadata 240b.

In some implementations, the one or more I/O devices 410 include a user-facing image sensor (e.g., the one or more image sensor(s) 222 of FIG. 2, which may be implemented as a front-facing camera or an inward-facing camera). In some implementations, the one or more I/O devices 410 include one or more head position sensors (e.g., the one or more head position sensor(s) 234 of FIG. 2) that sense the position and/or motion of the head of the user. The one or more head position sensor(s) 234 may include, for example, an accelerometer, a gyroscope, a magnetometer, and/or an inertial measurement unit (IMU). In some implementations, the one or more I/O devices 410 include a display for displaying the graphical environment (e.g., for displaying the XR environment 106). In some implementations, the one or more I/O devices 410 include a speaker for outputting an audible signal.

In various implementations, the one or more I/O devices 410 include a video passthrough display which displays at least a portion of a physical environment surrounding the device 400 as an image captured by a scene camera. In various implementations, the one or more I/O devices 410 include an optical see-through display which is at least partially transparent and passes light emitted by or reflected off the physical environment.

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

The present disclosure provides methods, systems, and/or devices for using a first user focus location and a second user focus location to activate an interface, such as a HUD interface. In some implementations, a device displays an interface when the device obtains a first user input associated with a first user focus location that corresponds to a first location within the user's field of view, followed by a second user input associated with a second user focus location that corresponds to a second location within the user's field of view. For example, the interface may be activated when the user gazes at a first location (e.g., toward an upper left corner of the field of view) and then gazes at a second location (e.g., toward an upper right corner of the field of view). The device may provide a cue to train the user by displaying an affordance (e.g., a red dot) at the first location that prompts the user to look at the affordance. In some implementations, the device may forgo displaying the affordance. For example, as the user becomes more familiar with the technique, the affordance may be gradually phased out and, eventually, omitted.

In some implementations, using the first and second user focus locations to activate the interface improves the user experience, e.g., by reducing inadvertent activations of the interface. The number of user inputs that are provided by the user may be reduced, for example, by reducing the number of inputs that are needed to correct for false positives. Battery life may be enhanced as a result.

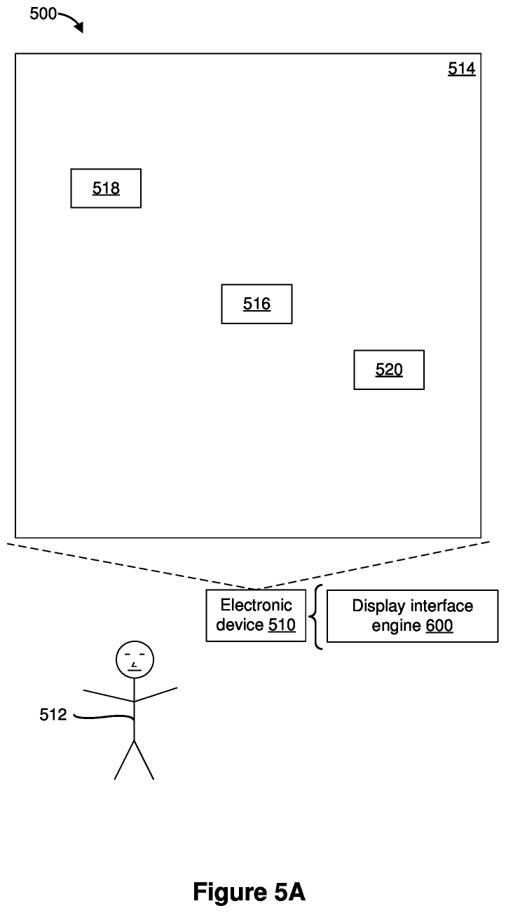

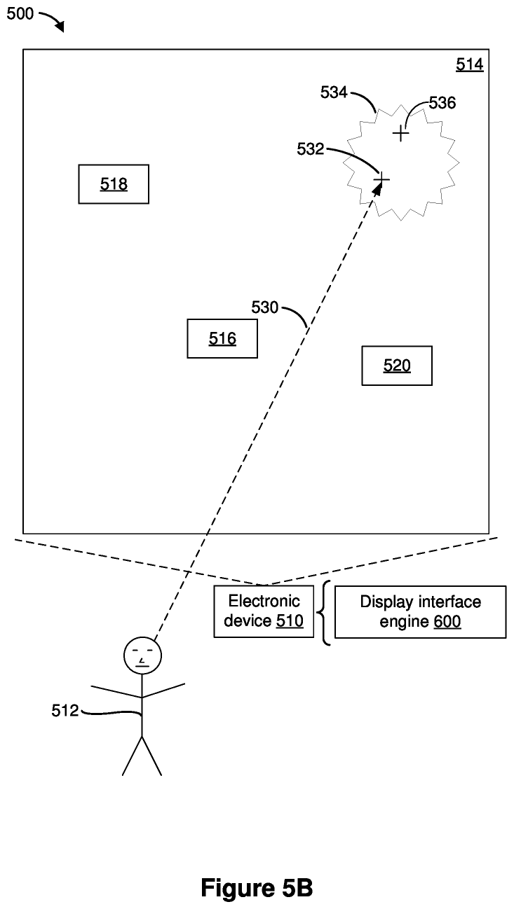

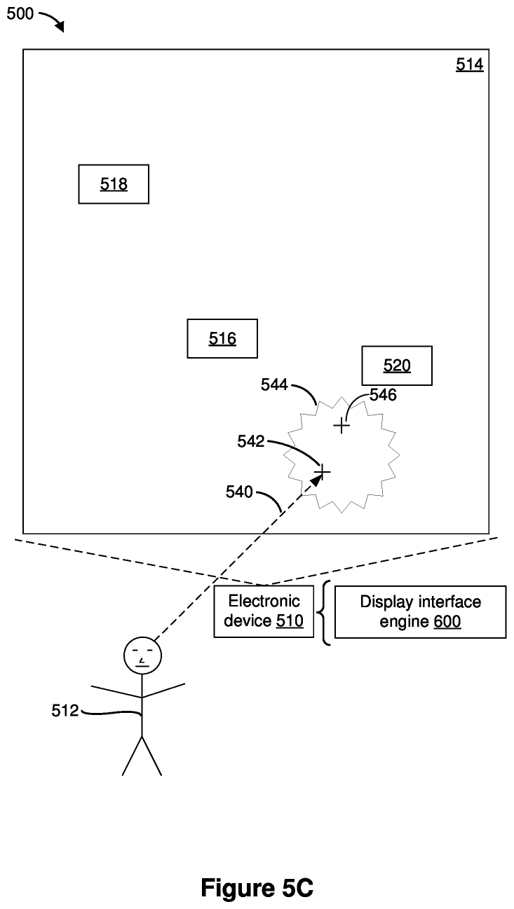

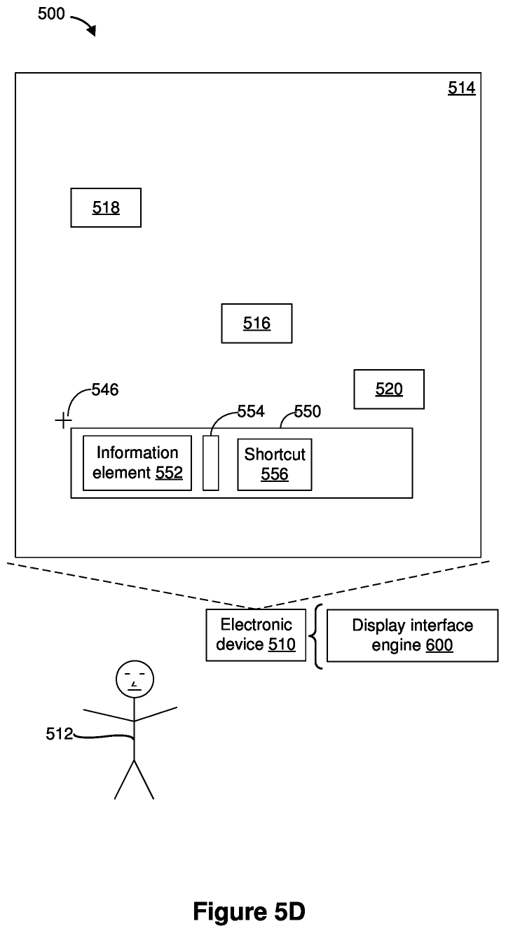

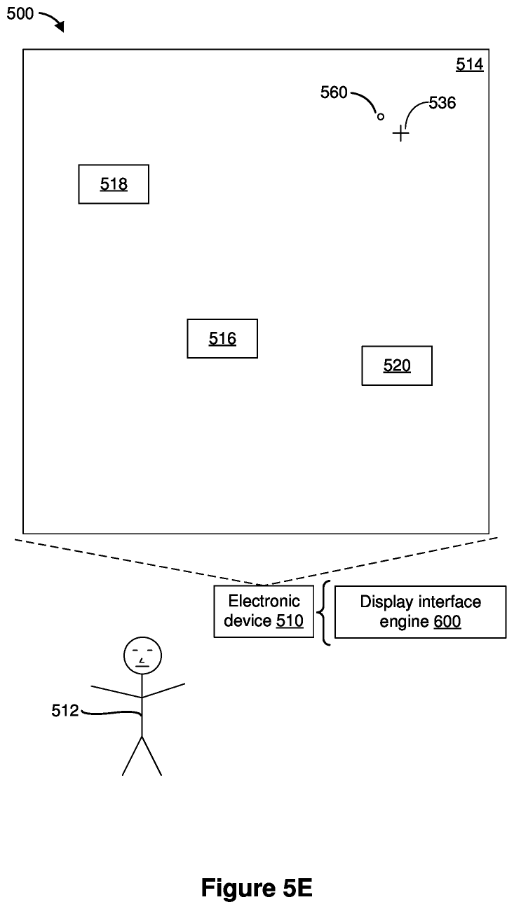

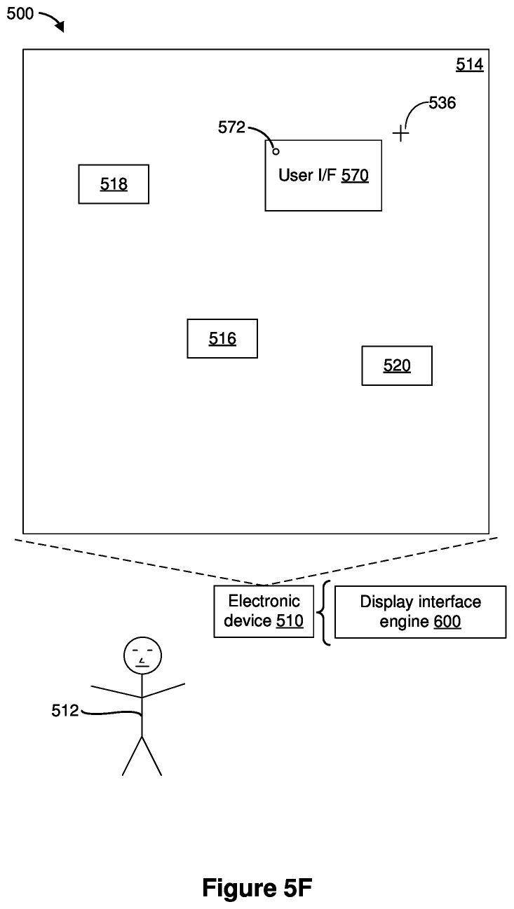

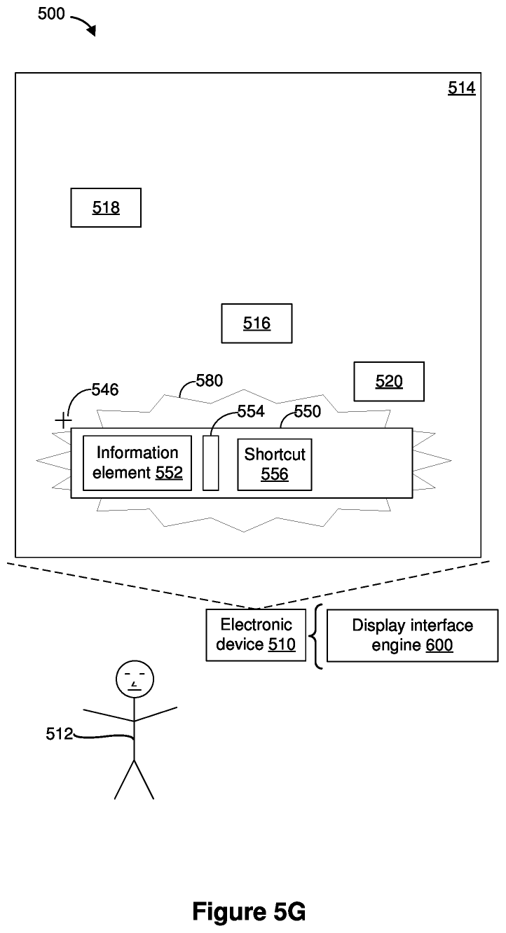

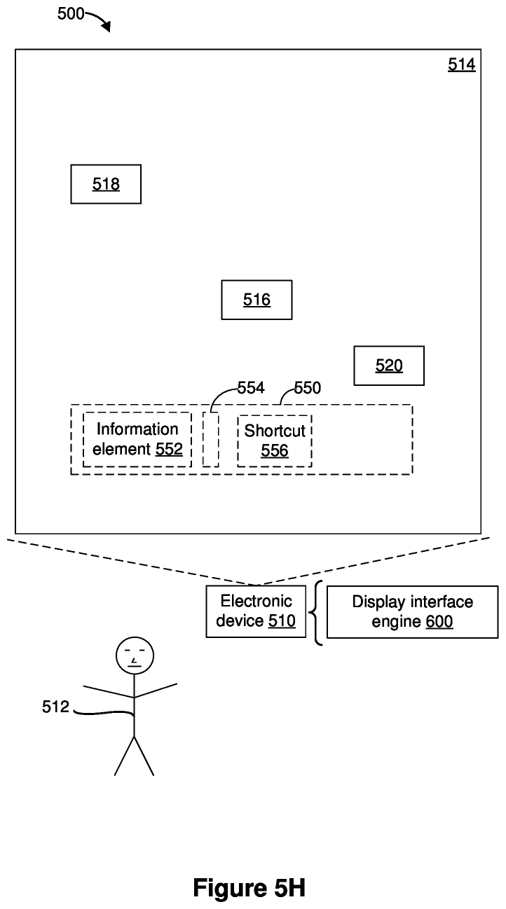

FIG. 5A is a block diagram of an example operating environment 500 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 500 includes an electronic device 510 and a display interface engine 600. In some implementations, the electronic device 510 includes a handheld computing device that can be held by a user 512. For example, in some implementations, the electronic device 510 includes a smartphone, a tablet, a media player, a laptop, or the like. In some implementations, the electronic device 510 includes a wearable computing device that can be worn by the user 512. For example, in some implementations, the electronic device 510 includes a head-mountable device (HMD) or an electronic watch.

In the example of FIG. 5A, the display interface engine 600 resides at the electronic device 510. For example, the electronic device 510 implements the display interface engine 600. In some implementations, the electronic device 510 includes a set of computer-readable instructions corresponding to the display interface engine 600. Although the display interface engine 600 is shown as being integrated into the electronic device 510, in some implementations, the display interface engine 600 is separate from the electronic device 510. For example, in some implementations, the display interface engine 600 resides at another device (e.g., at a controller, a server or a cloud computing platform).

As illustrated in FIG. 5A, in some implementations, the electronic device 510 presents an extended reality (XR) environment 514 that includes a field of view of the user 512. In some implementations, the XR environment 514 is referred to as a computer graphics environment. In some implementations, the XR environment 514 is referred to as a graphical environment. In some implementations, the electronic device 510 generates the XR environment 514. Alternatively, in some implementations, the electronic device 510 receives the XR environment 514 from another device that generated the XR environment 514.

In some implementations, the XR environment 514 includes a virtual environment that is a simulated replacement of a physical environment. In some implementations, the XR environment 514 is synthesized by the electronic device 510. In such implementations, the XR environment 514 is different from a physical environment in which the electronic device 510 is located. In some implementations, the XR environment 514 includes an augmented environment that is a modified version of a physical environment. For example, in some implementations, the electronic device 510 modifies (e.g., augments) the physical environment in which the electronic device 510 is located to generate the XR environment 514. In some implementations, the electronic device 510 generates the XR environment 514 by simulating a replica of the physical environment in which the electronic device 510 is located. In some implementations, the electronic device 510 generates the XR environment 514 by removing and/or adding items from the simulated replica of the physical environment in which the electronic device 510 is located.

In some implementations, the XR environment 514 includes various virtual objects such as an XR object 516 (“object 516”, hereinafter for the sake of brevity). In some implementations, the XR environment 514 includes multiple objects. In the example of FIG. 5A, the XR environment 514 includes XR objects 516, 518, and 520. In some implementations, the virtual objects are referred to as graphical objects or XR objects. In various implementations, the electronic device 510 obtains the virtual objects from an object datastore (not shown). For example, in some implementations, the electronic device 510 retrieves the object 516 from the object datastore. In some implementations, the virtual objects represent physical articles. For example, in some implementations, the virtual objects represent equipment (e.g., machinery such as planes, tanks, robots, motorcycles, etc.). In some implementations, the virtual objects represent fictional elements (e.g., entities from fictional materials, for example, an action figure or a fictional equipment such as a flying motorcycle).

In various implementations, as represented in FIG. 5B, the electronic device 510 (e.g., the display interface engine 600) receives a user input 530 corresponding to a user focus location 532. For example, the electronic device 510 may include a user-facing image sensor (e.g., a front-facing camera or an inward-facing camera). In some implementations, the user-facing image sensor captures a set of one or more images of the eyes of the user 512. The electronic device 510 may determine a gaze vector based on the set of one or more images. Based on the gaze vector, the electronic device 510 may determine that a gaze of the user 512 is directed to the user focus location 532. In some implementations, the electronic device 510 (e.g., the display interface 600) obtains a head pose value that corresponds to a head pose of the user 512. For example, the electronic device 510 may include one or more sensors that are configured to sense the position and/or motion of the head of the user 512. The one or more sensors may include, for example, an image sensor, an accelerometer, a gyroscope, a magnetometer, and/or an inertial measurement unit (IMU). Based on the head pose value, the electronic device 510 may determine that a head pose of the user 512 is directed to the user focus location 532.

In some implementations, the electronic device 510 displays a visual effect 534 in connection with the user focus location 532. For example, the electronic device 510 may display an area of increased brightness around the user focus location 532. As another example, the electronic device 510 may display a pointer at or near the user focus location 532.

In some implementations, the electronic device 510 determines that the user input 530 is directed to a target location 536 in the field of view of the user 512. This target location 536 can represent a first location for activating an interface. For example, the electronic device 510 may determine that the user focus location 532 corresponds to the target location 536. In some implementations, the electronic device 510 determines that the user focus location 532 corresponds to the target location 536 if the user focus location 532 satisfies a proximity criterion relative to the target location 536. In some implementations, the electronic device 510 determines that the user focus location 532 corresponds to the target location 536 if the user focus location 532 satisfies the proximity criterion for a threshold duration.

In some implementations, as represented in FIG. 5C, the electronic device 510 (e.g., the display interface engine 600) receives a user input 540 corresponding to a user focus location 542. For example, the electronic device 510 may include a user-facing image sensor (e.g., a front-facing camera or an inward-facing camera). In some implementations, the user-facing image sensor captures a set of one or more images of the eyes of the user 512. The electronic device 510 may determine a gaze vector based on the set of one or more images. Based on the gaze vector, the electronic device 510 may determine that a gaze of the user 512 is directed to the user focus location 542. In some implementations, the electronic device 510 (e.g., the display interface 600) obtains a head pose value that corresponds to a head pose of the user 512. For example, the electronic device 510 may include one or more sensors that are configured to sense the position and/or motion of the head of the user 512. The one or more sensors may include, for example, an image sensor, an accelerometer, a gyroscope, a magnetometer, and/or an inertial measurement unit (IMU). Based on the head pose value, the electronic device 510 may determine that a head pose of the user 512 is directed to the user focus location 542.

In some implementations, the electronic device 510 displays a visual effect 544 in connection with the user focus location 542. For example, the electronic device 510 may display an area of increased brightness around the user focus location 542. As another example, the electronic device 510 may display a pointer at or near the user focus location 542.

In some implementations, the electronic device 510 determines that the user input 540 is directed to a target location 546 that is different from the target location 536. The target location 546 may represent a second location for confirming activation of the interface. For example, the electronic device 510 may determine that the user focus location 542 corresponds to the target location 546. In some implementations, the electronic device 510 determines that the user focus location 542 corresponds to the target location 546 if the user focus location 542 satisfies a proximity criterion relative to the target location 546. In some implementations, the electronic device 510 determines that the user focus location 542 corresponds to the target location 546 if the user focus location 542 satisfies the proximity criterion for a threshold duration. While target location 546 is shown as a point on the display of electronic device 510, in other examples, the target location 546 can include a region of the display of electronic device 510, a point within XR environment 514, or a region within XR environment 514. In some implementations using head pose, the target location 546 can be a defined as a direction relative to an initial head pose, such as an upward rotation about the pitch axis.

In some implementations, in response to determining that the user input 530 is directed to the target location 536 shown in FIG. 5B, an affordance may be presented at target location 546. The affordance can include any visual indicator, such as a dot, icon, button, or the like. Presenting an affordance at target location 546 may assist a user in identifying the location at which they should direct their input to confirm activation of the interface. In some implementations the affordance may be obscured (e.g., ceased to be displayed) in response to a threshold duration or in response to detecting a user input directed to the affordance. For example, the affordance may be obscured (e.g., ceased to be displayed) when the user 512 gestures toward the affordance, gazes at the affordance, or makes a head motion toward the affordance.

In some implementations, additional information may be presented in response to determining that the user input 530 is directed to the target location 536 and before the user input 540 is directed to the target location 546. For example, different information or a subset of information available in the interface that a user may want to quickly access, such as the time, notifications, messages, or the like, may be displayed. In some implementations the additional information may be obscured (e.g., ceased to be displayed) in response to a threshold duration, in response to detecting no user input directed to the additional information, or in response to detecting a user input directed to the affordance located at target location 546 mentioned above.

In some implementations, as represented by FIG. 5D, the electronic device 510 displays a user interface 550 on the display or in the XR environment 514 in response to obtaining the user input 530 directed to the target location 536 and the user input 540 directed to the target location 546. For example, if the target location 536 is located near an upper left corner of the field of view and the target location 546 is located near an upper right corner of the field of view, the electronic device 510 may display the user interface 550 when the user 512 gazes at the upper left corner of the field of view and then gazes at the upper right corner of the field of view.

In some implementations, the user interface 550 is displayed proximate the target location 546 and includes one or more user interface elements. For example, the user interface 550 may include an information element 552 that displays information, e.g., from an application executing on the electronic device 510 and/or on another device. In some implementations, the user interface 550 includes an affordance 554. The user 512 may provide an input to the affordance 554 and control an application executing on the electronic device 510 and/or on another device. In some implementations, the user interface 550 includes a shortcut 556. The user 512 may provide an input to the shortcut 556 and open an application executing on the electronic device 510 and/or on another device and/or may access a content item stored on the electronic device 510 and/or on another device.

In some implementations, as represented in FIG. 5E, the electronic device 510 displays an affordance 560 at the target location 536. The affordance 560 may be used to train the user 512 to provide the user input 530 that initiates the process of displaying the user interface 550. In some implementations, the electronic device 510 displays the affordance 560 on the display or in the XR environment 514. The affordance 560 may be obscured (e.g., cease to be displayed) after a condition is satisfied. For example, the electronic device 510 may obscure the affordance 560 after the user interface 550 has been displayed for a threshold duration. In some implementations, the electronic device 510 obscures the affordance 560 after the user interface 550 has been displayed a threshold number of times. In some implementations, the electronic device 510 obscures (e.g., ceases to display) the affordance 560 in response to detecting a user input directed to the affordance 560. For example, the affordance 560 may be obscured (e.g., ceased to be displayed) when the user 512 gestures toward the affordance 560, gazes at the affordance 560, or makes a head motion toward the affordance 560. In some implementations, the electronic device 510 forgoes display of the affordance 560 in response to determining that a user interface activation score is greater than a threshold activation score (e.g., an activation rate of the user interface 550 is greater than a threshold activation rate) indicating that the user has become accustomed to using first and second user focus locations to activate display of the user interface 550. In some implementations, affordance 560 can be displayed near target location 536 using a light or display separate from the primary display of electronic device 510. For example, LEDs may be positioned around the display and one or more of these may be illuminated to indicate a direction at which the user should gaze or move their head to initiate activation of the interface.

In some implementations, as represented in FIG. 5F, the electronic device 510 displays a user interface 570 at the target location 536. The user interface 570 may be used to train the user 512 to provide the user input 530 that initiates the process of displaying the user interface 550. In some implementations, the electronic device 510 displays the user interface 570 in the XR environment 514. The user interface 570 may be visually simpler (e.g., may include fewer user interface elements) than the user interface 550. For example, the user interface 570 may include a single user interface element 572, such as an information element, affordance, or shortcut. In some implementations, the user interface 570 is displayed whenever the XR environment 514 is displayed. In some implementations, the user interface 570 is displayed when the user focus location 532 corresponds to (e.g., satisfies a proximity criterion relative to) the target location 536. In some implementations, the user interface 570 is displayed when the user focus location 532 satisfies a proximity criterion relative to the target location 536 for a threshold duration.

In some implementations, as represented in FIG. 5G, the electronic device 510 changes one or more visual properties of the user interface 550, e.g., in response to a user input directed to the user interface 550. The electronic device 510 may change the one or more visual properties of the user interface 550, for example, to enhance visibility of the user interface 550. In some implementations, the electronic device 510 displays a visual effect 580 in connection with the user interface 550. For example, the electronic device 510 may change the brightness of the user interface 550. In some implementations, the electronic device 510 changes the contrast between the user interface 550 and the XR environment 514, e.g., a passthrough portion of the XR environment 514. In some implementations, the electronic device 510 changes a color of the user interface 550, e.g., to enhance the visibility of the user interface 550. In some implementations, the electronic device 510 changes a size of the user interface 550. For example, the electronic device 510 may display the user interface 550 in a larger size. In some implementations, the electronic device 510 displays an animation in connection with the user interface 550.

In some implementations, as represented in FIG. 5H, the electronic device 510 obscures the user interface 550, e.g., after a dismissal condition has occurred. For example, the electronic device 510 may remove (e.g., cease to display) the user interface 550 from the XR environment 514 after a threshold duration has elapsed after a user input directed to the user interface 550 has been detected. In some implementations, the electronic device 510 ceases displaying the user interface 550 after the user interface 550 has been displayed for a threshold duration. In some implementations, the electronic device 510 ceases displaying the user interface 550 in response to detecting a particular user input, e.g., directed to the user interface 550. For example, the user may perform a specified gesture (e.g., a motion of an extremity or a head) to cause the user interface 550 to be dismissed.

In some implementations, the user interface 550 is obscured by removing the user interface 550 from the XR environment 514, e.g., by ceasing to display the user interface 550. The user interface 550 may be obscured by changing one or more visual properties of the user interface 550 to make the user interface 550 less prominent. For example, the electronic device 510 may decrease the brightness of the user interface 550. As another example, the electronic device 510 may increase the transparency of the user interface 550. In some implementations, the electronic device 510 decreases the contrast between the user interface 550 and the XR environment 514, e.g., a passthrough portion of the XR environment 514. In some implementations, the electronic device 510 changes a color of the user interface 550, e.g., to reduce the visibility of the user interface 550. In some implementations, the electronic device 510 changes a size of the user interface 550. For example, the electronic device 510 may display the user interface 550 in a smaller size.

In some implementations, the electronic device 510 includes or is attached to a head-mountable device (HMD) worn by the user 512. The HMD presents (e.g., displays) the XR environment 514 according to various implementations. In some implementations, the HMD includes an integrated display (e.g., a built-in display) that displays the XR environment 514. In some implementations, the HMD includes a head-mountable enclosure. In various implementations, the head-mountable enclosure includes an attachment region to which another device with a display can be attached. For example, in some implementations, the electronic device 510 can be attached to the head-mountable enclosure. In various implementations, the head-mountable enclosure is shaped to form a receptacle for receiving another device that includes a display (e.g., the electronic device 510). For example, in some implementations, the electronic device 510 slides/snaps into or otherwise attaches to the head-mountable enclosure. In some implementations, the display of the device attached to the head-mountable enclosure presents (e.g., displays) the XR environment 514. In various implementations, examples of the electronic device 510 include smartphones, tablets, media players, laptops, etc.

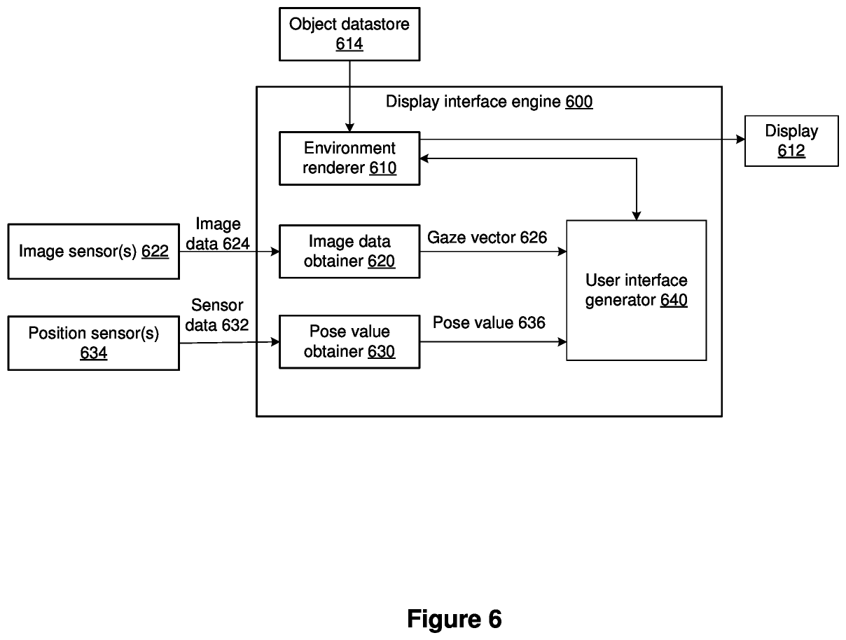

FIG. 6 is a block diagram of a display interface engine 600 in accordance with some implementations. In some implementations, the display interface engine 600 includes an environment renderer 610, an image data obtainer 620, a head pose value obtainer 630, and/or a user interface generator 640. In various implementations, the environment renderer 610 outputs image data for presenting an extended reality (XR) environment that includes a set of virtual objects in a field of view. For example, with reference to FIG. 5A, the environment renderer 610 may output image data for presenting the XR environment 514, including virtual objects 516, 518, and 520, on a display 612. In various implementations, the environment renderer 610 obtains the virtual objects from an object datastore 614. The virtual objects may represent physical articles. For example, in some implementations, the virtual objects represent equipment (e.g., machinery such as planes, tanks, robots, motorcycles, etc.). In some implementations, the virtual objects represent fictional elements. In some implementations where display 612 includes an opaque display, environment renderer 610 may output image data for the XR environment 514 that represents virtual objects and representations of physical objects (e.g., pass-through images from an image sensor). In other implementations where display 612 includes a transparent or translucent display, environment renderer 610 may output image data for the XR environment 514 that represents only virtual objects.

In some implementations, the image data obtainer 620 obtains sensor data from one or more image sensor(s) 622 that capture one or more images of a user, e.g., the user 512 of FIG. 5A. For example, a user-facing image sensor (e.g., a front-facing camera or an inward-facing camera) may capture a set of one or more images of the eyes of the user 512 and may generate image data 624. The image data obtainer 620 may obtain the image data 624. In some implementations, the image data obtainer 620 determines a gaze vector 626 based on the image data 624. The display interface engine 600 may determine, based on the gaze vector 626, that the gaze of the user 512 is directed to a location within the field of view, e.g., the user focus location 532 and/or the user focus location 542.

In some implementations, the head pose value obtainer 630 obtains head sensor data 632 from one or more head position sensor(s) 634 that sense the position and/or motion of the head of the user 512. The one or more head position sensor(s) 634 may include, for example, an image sensor, an accelerometer, a gyroscope, a magnetometer, and/or an inertial measurement unit (IMU). The head pose value obtainer 630 may generate a head pose value 636 based on the head sensor data 632. The head pose value obtainer 630 may determine that the head pose value 636 corresponds to an orientation of the head of the user 512 toward a location within the field of view, e.g., the user focus location 532 and/or the user focus location 542.

It will be appreciated that, in some implementations, the image data obtainer 620 or the head pose value obtainer 630 may be omitted. For example, in some implementations, the user input 530 and the user input 540 may be gaze inputs. In such implementations, the head pose value obtainer 630 may be omitted. As another example, in some implementations, the user input 530 and the user input 540 may be head sensor data. Such implementations may omit the image data obtainer 620.

In some implementations, the user interface generator 640 causes a user interface to be displayed, e.g., in the XR environment 514, on a condition that the user focus location 532 corresponds to the target location 536 and the user focus location 542 corresponds to the target location 546. For example, if the target location 536 is in an upper left corner of the field of view of the user 512 and the target location 546 is in an upper right corner of the field of view, the user interface generator 640 may generate a user interface and insert the user interface into the XR environment 514 to be rendered by the environment renderer 610 if the user 512 looks to the upper left corner of the field of view and then looks to the upper right corner of the field of view.

In some implementations, the user interface generator 640 modifies the XR environment 514 to generate a modified XR environment that includes a representation of the user interface. In some implementations, the user interface generator 640 triggers display of the user interface in response to a determination that the user focus location 532 corresponds to the target location 536 and the user focus location 542 corresponds to the target location 546. In some implementations, if the user focus location 532 corresponds to the target location 536 but the user focus location 542 does not correspond to the target location 546 (e.g., the user 512 looks at the target location 536 but then looks away from the target location 546), the user interface generator 640 does not trigger display of the user interface.

In some implementations, the environment renderer 610 and/or the user interface generator 640 displays an affordance to train the user 512 to provide the user input 530 that initiates the process of displaying the user interface. The affordance may be obscured (e.g., cease to be displayed) after a condition is satisfied. For example, the affordance may be obscured after the user interface has been displayed for a threshold duration. In some implementations, the affordance may be obscured after the user interface has been displayed a threshold number of times. In some implementations, the affordance may be obscured in response to detecting a user input directed to the affordance. For example, the affordance may be obscured when the user 512 gestures toward the affordance or makes a head motion toward the affordance. In some implementations, the affordance is obscured in response to determining that a user interface activation score is greater than a threshold activation score (e.g., an activation rate of the user interface is greater than a threshold activation rate) indicating that the user has become accustomed to using first and second user focus locations to activate display of the user interface.

In some implementations, the user interface generator 640 enhances the visibility of the user interface by changing one or more visual properties of the user interface. For example, the user interface generator 640 may change the brightness of the user interface. In some implementations, the user interface generator 640 changes the contrast between the user interface and the XR environment 514, e.g., a passthrough portion of the XR environment 514. In some implementations, the user interface generator 640 changes a color of the user interface. In some implementations, the user interface generator 640 increases a size of the user interface.

In some implementations, the user interface generator 640 removes or reduces the visibility of the user interface, e.g., after a dismissal condition has occurred. For example, the user interface generator 640 may cease displaying the user interface after a threshold duration has elapsed after a user input directed to the user interface has been detected. In some implementations, the user interface generator 640 ceases displaying the user interface after the user interface has been displayed for a threshold duration. In some implementations, the user interface generator 640 ceases displaying the user interface in response to detecting a particular user input, e.g., directed to the user interface. For example, the user may perform a specified gesture (e.g., a motion of an extremity or a head) to cause the user interface to be dismissed.

The visibility of the user interface may be reduced by changing one or more visual properties of the user interface. For example, the user interface generator 640 may decrease the brightness of the user interface. As another example, the user interface generator 640 may increase the transparency of the user interface. In some implementations, the user interface generator 640 decreases the contrast between the user interface and the XR environment 514, e.g., a passthrough portion of the XR environment 514. In some implementations, the user interface generator 640 changes a color of the user interface. In some implementations, the user interface generator 640 reduces a size of the user interface.

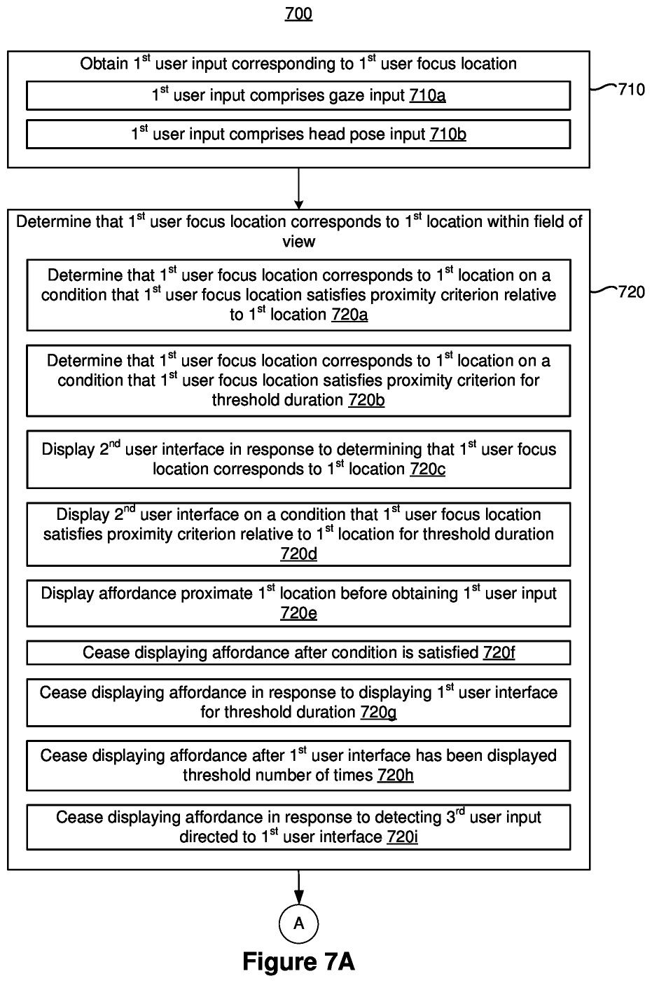

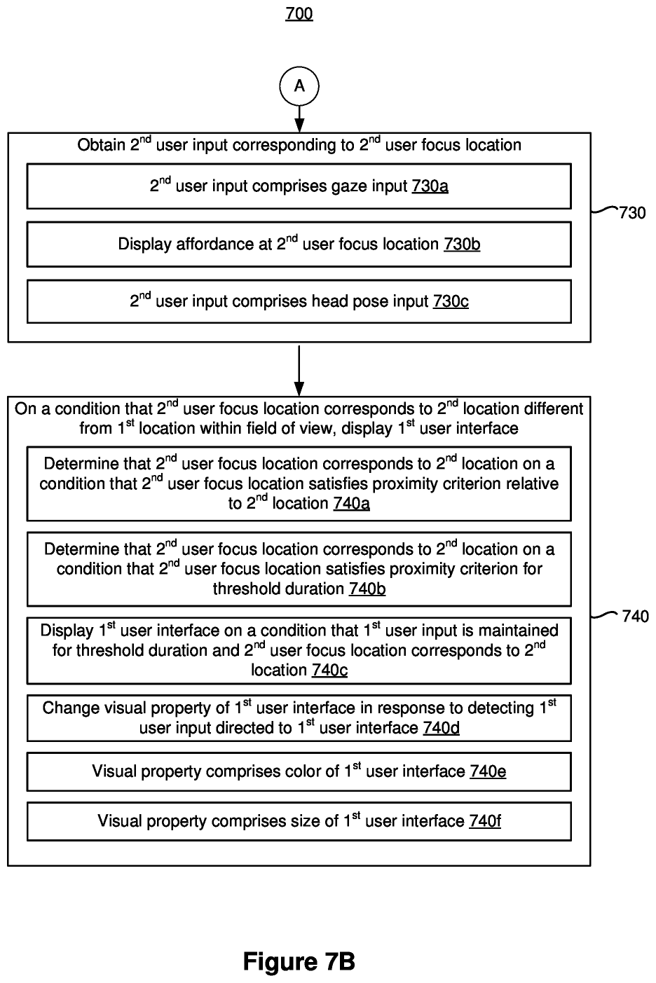

FIGS. 7A-7B are a flowchart representation of a method 700 of using first and second user focus locations to activate an interface in accordance with some implementations. In various implementations, the method 700 is performed by a device (e.g., the electronic device 510 shown in FIGS. 5A-5H, or the display interface engine 600 shown in FIGS. 5A-5H and 6). In some implementations, the method 700 is performed by processing logic, including hardware, firmware, software, or a combination thereof. In some implementations, the method 700 is performed by a processor executing code stored in a non-transitory computer-readable medium (e.g., a memory).

In various implementations, an XR environment comprising a field of view is displayed. In some implementations, the XR environment is generated. In some implementations, the XR environment is received from another device that generated the XR environment. The XR environment may include a virtual environment that is a simulated replacement of a physical environment. In some implementations, the XR environment is synthesized and is different from a physical environment in which the electronic device is located. In some implementations, the XR environment includes an augmented environment that is a modified version of a physical environment. For example, in some implementations, the electronic device modifies the physical environment in which the electronic device is located to generate the XR environment. In some implementations, the electronic device generates the XR environment by simulating a replica of the physical environment in which the electronic device is located. In some implementations, the electronic device removes and/or adds items from the simulated replica of the physical environment in which the electronic device is located to generate the XR environment.

In some implementations, the electronic device includes a head-mountable device (HMD). The HMD may include an integrated display (e.g., a built-in display) that displays the XR environment. In some implementations, the HMD includes a head-mountable enclosure. In various implementations, the head-mountable enclosure includes an attachment region to which another device with a display can be attached. In various implementations, the head-mountable enclosure is shaped to form a receptacle for receiving another device that includes a display. In some implementations, the display of the device attached to the head-mountable enclosure presents (e.g., displays) the XR environment. In various implementations, examples of the electronic device include smartphones, tablets, media players, laptops, etc.

In various implementations, as represented by block 710, the method 700 includes obtaining a first user input that corresponds to a first user focus location. For example, as represented by block 710a, the first user input may include a gaze input. In some implementations, sensor data may be obtained from one or more image sensor(s) that capture one or more images of a user. For example, a user-facing image sensor (e.g., a front-facing camera or an inward-facing camera) may capture a set of one or more images of the eyes of the user and may generate image data from which a gaze vector may be determined. The gaze vector may correspond to the first user focus location.

In some implementations, as represented by block 710b, the first user input includes a head pose input. For example, head sensor data may be obtained from one or more head position sensor(s) that sense the position and/or motion of the head of the user. The one or more head position sensor(s) may include, for example, an image sensor, an accelerometer, a gyroscope, a magnetometer, and/or an inertial measurement unit (IMU). A head pose value may be determined based on the head sensor data. The head pose value may correspond to an orientation of the head of the user toward a location within the field of view, e.g., the first user focus location.

In various implementations, as represented by block 720, the method 700 includes determining that the first user focus location corresponds to a first location within a field of view. For example, as represented by block 720a, the method 700 may include determining that first user focus location corresponds to the first location on a condition that the first user focus location satisfies a proximity criterion relative to the first location. In some implementations, as represented by block 720b, the electronic device 510 determines that the first user focus location corresponds to the first location if the first user focus location satisfies the proximity criterion for a threshold duration.

In some implementations, as represented by block 720c, a second user interface is displayed in response to determining that the first user focus location corresponds to the first location. The second user interface may be used to train the user to provide the user input that initiates the process of displaying a first user interface, e.g., the user interface 550 of FIG. 5D. The second user interface may be visually simpler (e.g., may include fewer user interface elements) than the first user interface. For example, the second user interface may include a single user interface element, such as an information element, affordance, or shortcut. In some implementations, the second user interface is displayed whenever the XR environment is displayed. In some implementations, as represented by block 720d, the second user interface is displayed when the first user focus location satisfies a proximity criterion relative to the first location for a threshold duration.

In some implementations, as represented by block 720e, the method 700 includes displaying an affordance proximate the first location. The affordance may be displayed before obtaining the first user input corresponding to the first user focus location. The affordance may be used to train the user to provide the user input that initiates the process of displaying the first user interface. As represented by block 720f, the affordance may cease to be displayed after a condition is satisfied. For example, as represented by block 720g, the electronic device 510 may cease to display the affordance after the first user interface 550 has been displayed for a threshold duration. In some implementations, as represented by block 720h, the electronic device 510 ceases to display the affordance after the first user interface has been displayed a threshold number of times. In some implementations, as represented by block 720i, the electronic device 510 ceases to display the affordance in response to detecting the first user input directed to the affordance. For example, the affordance may be obscured (e.g., ceased to be displayed) when the user gestures toward the affordance or makes a head motion toward the affordance. In some implementations, the electronic device 510 forgoes display of the affordance in response to determining that a user interface activation score is greater than a threshold activation score (e.g., an activation rate of the user interface is greater than a threshold activation rate) indicating that the user has become accustomed to using first and second user focus locations to activate display of the user interface.

In various implementations, as represented by block 730 of FIG. 7B, the method 700 includes obtaining a second user input corresponding to a second user focus location. For example, as represented by block 730a, the second user input may include a gaze input. In some implementations, sensor data may be obtained from one or more image sensor(s) that capture one or more images of a user. For example, a user-facing image sensor (e.g., a front-facing camera or an inward-facing camera) may capture a set of one or more images of the eyes of the user and may generate image data from which a gaze vector may be determined. The gaze vector may correspond to the second user focus location.

In various implementations, as represented by block 730b, an affordance is displayed at the second user focus location, e.g., before obtaining the second user input. For example, a dot may be displayed at the second user focus location in response to the first user focus location corresponding to the first location. The affordance may provide a visual cue to the user to inform the user of the second location to look to cause the user interface to be displayed. In some implementations, the affordance provides a visual cue to inform the user of a direction toward which a head motion should be directed to cause the user interface to be displayed. In some implementations, the affordance may cease to be displayed after a condition is satisfied. For example, the affordance may cease to be displayed after the affordance has been displayed for a threshold duration. As another example, the affordance may cease to be displayed in response to the second user input corresponding to the second location or to the affordance. In some implementations, the affordance ceases to be displayed in response to a user request.

In some implementations, as represented by block 730c, the second user input includes a head pose input. For example, head sensor data may be obtained from one or more head position sensor(s) that sense the position and/or motion of the head of the user. The one or more head position sensor(s) may include, for example, an image sensor, an accelerometer, a gyroscope, a magnetometer, and/or an inertial measurement unit (IMU). A head pose value may be determined based on the head sensor data. The head pose value may correspond to an orientation of the head of the user toward a location within the field of view, e.g., the second user focus location.

In various implementations, as represented by block 740, the method 700 includes displaying a first user interface on a condition that the second user focus location corresponds to a second location different from the first location within the field of view. In some implementations, conditioning activation of the first user interface on receiving user inputs directed to different user focus locations reduces the incidence of false positives and inadvertent activations of the first user interface during normal use. The number of user inputs that are provided by the user may be reduced, for example, by reducing the number of inputs that are needed to correct for false positives. Battery life may be enhanced as a result. As represented by block 740a, the method 700 may include determining that the second user focus location corresponds to the second location on a condition that the second user focus location satisfies a proximity criterion relative to the second location. In some implementations, as represented by block 740b, the electronic device 510 determines that the second user focus location corresponds to the second location if the second user focus location satisfies the proximity criterion for a threshold duration.

In some implementations, as represented by block 740c, the electronic device 510 displays the first user interface on a condition that the first user input is maintained for a threshold duration and the second user focus location corresponds to the second location. For example, the user may be required to gaze at the first location for the threshold duration before gazing at the second location. Requiring the user to hold a gaze at the first location may reduce the incidence of false positives and reduce inadvertent activations of the first user interface. The number of user inputs that are provided by the user may be reduced, for example, by reducing the number of inputs that are needed to correct for false positives. Battery life may be enhanced as a result.

In some implementations, as represented by block 740d, a visual property of the first user interface is changed in response to detecting a third user input directed to the first user interface. The visual property may be changed to increase or decrease the visibility of the first user interface. For example, as represented by block 740e, the visual property may include a color of the first user interface. The color of the first user interface may be changed to make the first user interface more visible or less visible against the background. In some implementations, as represented by block 740f, the visual property includes a size of the first user interface. For example, the first user interface may be enlarged to make the first user interface more prominent. As another example, the first user interface may be reduced to make the first user interface less prominent.

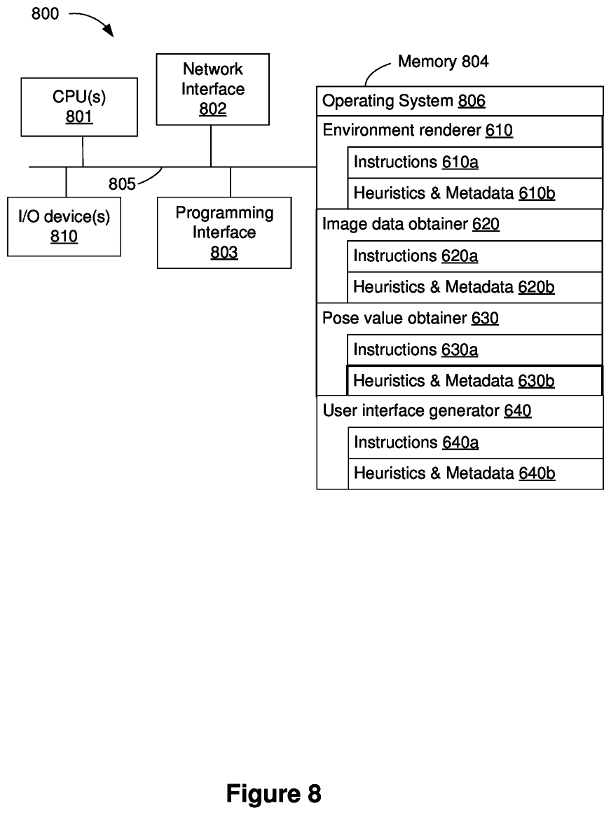

FIG. 8 is a block diagram of a device 800 that uses first and second user focus locations to activate a HUD interface in accordance with some implementations. In some implementations, the device 800 implements the electronic device 510 shown in FIGS. 5A-5H and/or the display interface engine 600 shown in FIGS. 5A-5H and 6. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 800 includes one or more processing units (CPUs) 801, a network interface 802, a programming interface 803, a memory 804, one or more input/output (I/O) devices 810, and one or more communication buses 805 for interconnecting these and various other components.

In some implementations, the network interface 802 is provided to, among other uses, establish and maintain a metadata tunnel between a cloud hosted network management system and at least one private network including one or more compliant devices. In some implementations, the one or more communication buses 805 include circuitry that interconnects and controls communications between system components. The memory 804 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. The memory 804 optionally includes one or more storage devices remotely located from the one or more CPUs 801. The memory 804 comprises a non-transitory computer readable storage medium.

In some implementations, the memory 804 or the non-transitory computer readable storage medium of the memory 804 stores the following programs, modules and data structures, or a subset thereof including an optional operating system 806, the environment renderer 610, the image data obtainer 620, the head pose value obtainer 630, and the user interface generator 640. In various implementations, the device 800 performs the method 700 shown in FIGS. 7A-7B.

In some implementations, the environment renderer 610 displays an extended reality (XR) environment that includes a set of virtual objects in a field of view. In some implementations, the environment renderer 610 includes instructions 610a and heuristics and metadata 610b.

In some implementations, the image data obtainer 620 obtains sensor data from one or more image sensors that capture one or more images of a user, e.g., the user 512 of FIG. 5A. In some implementations, the image data obtainer 620 determines a gaze vector. In some implementations, the image data obtainer 620 performs the operation(s) represented by blocks 710, 720, and/or 730 in FIGS. 7A-7B. To that end, the image data obtainer 620 includes instructions 620a and heuristics and metadata 620b.

In some implementations, the head pose value obtainer 630 obtains head sensor data from one or more head position sensors that sense the position and/or motion of the head of the user 512. The one or more head position sensors may include, for example, an accelerometer, a gyroscope, a magnetometer, and/or an inertial measurement unit (IMU). The head pose value obtainer 630 may generate a head pose value based on the head sensor data. In some implementations, the head pose value obtainer 630 performs the operations represented by blocks 710, 720, and/or 730 in FIGS. 7A-7B. To that end, the head pose value obtainer 630 includes instructions 630a and heuristics and metadata 630b.

In some implementations, the user interface generator 640 causes a user interface to be displayed, e.g., in the XR environment 514, on a condition that the user focus location 532 corresponds to the target location 536 and the user focus location 542 corresponds to the target location 546. In some implementations, the user interface generator 640 performs the operations represented by block 740 in FIGS. 7A-7B. To that end, the user interface generator 640 includes instructions 640a and heuristics and metadata 640b.

In some implementations, the one or more I/O devices 810 include a user-facing image sensor (e.g., the one or more image sensor(s) 622 of FIG. 6, which may be implemented as a front-facing camera or an inward-facing camera). In some implementations, the one or more I/O devices 810 include one or more head position sensors (e.g., the one or more head position sensor(s) 634 of FIG. 6) that sense the position and/or motion of the head of the user. The one or more head position sensor(s) 634 may include, for example, an accelerometer, a gyroscope, a magnetometer, and/or an inertial measurement unit (IMU). In some implementations, the one or more I/O devices 810 include a display for displaying the graphical environment (e.g., for displaying the XR environment 514). In some implementations, the one or more I/O devices 810 include a speaker for outputting an audible signal.

In various implementations, the one or more I/O devices 810 include a video passthrough display which displays at least a portion of a physical environment surrounding the device 800 as an image captured by a scene camera. In various implementations, the one or more I/O devices 810 include an optical see-through display which is at least partially transparent and passes light emitted by or reflected off the physical environment.

It will be appreciated that FIG. 8 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 8 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

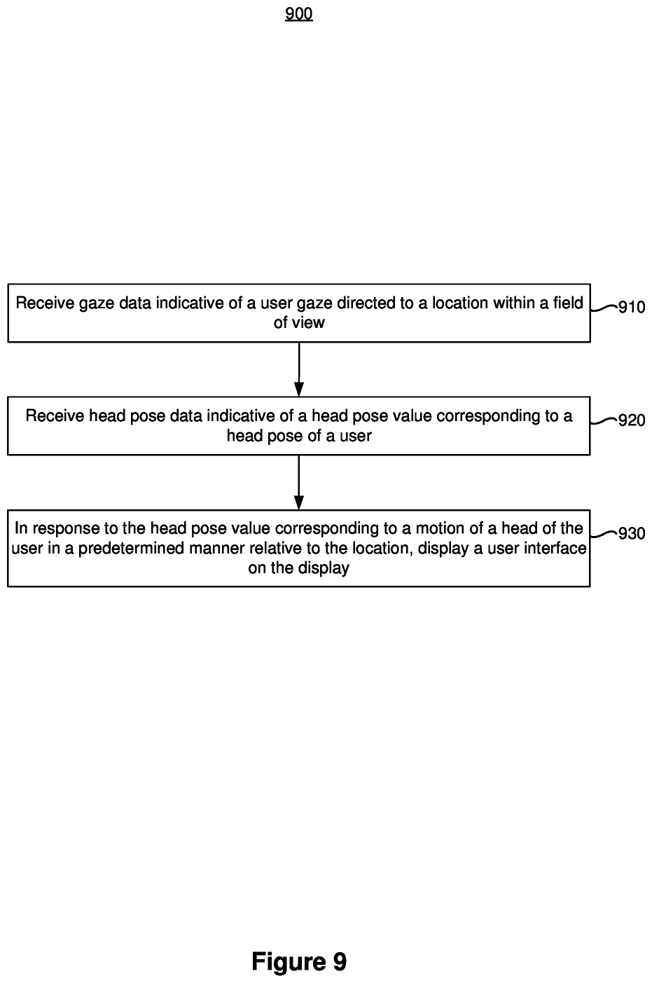

FIG. 9 is a flowchart representation of a method 900 of displaying a user interface based on gaze and head motion in accordance with some implementations. In various implementations, the method 900 is performed by a device that includes one or more sensors, a display, one or more processors and a non-transitory memory (e.g., the electronic device 100 shown in FIG. 1A).

As represented by block 910, in various implementations, the method 900 includes receiving, via the one or more sensors, gaze data indicative of a user gaze directed to a location within a field of view. In some implementations, receiving the gaze data includes utilizing an application programming interface (API) that provides the gaze data. For example, an application may make an API call to obtain the gaze data.

As represented by block 920, in various implementations, the method 900 includes receiving, via the one or more sensors, head pose data indicative of a head pose value corresponding to a head pose of a user. In some implementations, receiving the head pose data includes utilizing an API that provides the head pose data. For example, an application may make an API call to obtain the head pose data. In some implementations, receiving the head pose data includes receiving an indication of a rotation of the head toward the location within the field of view. In some implementations, the rotation includes a rotation of a head-forward vector toward the location within the field of view. In some implementations, the head pose value includes a head pose vector that includes a set of one or more head pose values. In some implementations, the head pose value includes a single head pose value.

As represented by block 930, in various implementations, the method 900 includes, in response to the head pose value corresponding to a motion of a head of the user in a predetermined manner relative to the location, displaying a user interface on the display. For example, an application may display the user interface 140 shown in FIG. 1D when the user is gazing at the location and moving his/her head in the predetermined manner.

In some implementations, the method 900 includes displaying, on the display, a visual indicator proximate to the location (e.g., at the location or adjacent to the location). In some implementations, the method 900 includes displaying, on the display, proximate to the location, an affordance that, when activated by gazing at the affordance and moving the head in the predetermined manner, triggers display of the user interface on the display (e.g., displaying the affordance 150 shown in FIG. 1E). In some implementations, the method 900 includes forgoing display of the user interface on the display in response to the user gaze being directed to the location and the motion of the head of the user not being in the predetermined manner relative to the location. For example, not displaying the user interface 140 shown in FIG. 1D when the user does not move his/her head in the predetermined manner even though the user may be gazing at the location.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

1-76. (canceled)

77. A method comprising:
at a device comprising a sensor, a display, one or more processors, and a memory:
obtaining a first user input corresponding to a first user focus location;
determining that the first user focus location corresponds to a first location within a field of view;
obtaining a second user input corresponding to a second user focus location; and
on a condition that the second user focus location corresponds to a second location different from the first location within the field of view, displaying a first user interface.

78. The method of claim 77, wherein the first user input comprises a gaze input.

79. The method of claim 77, wherein the first user input comprises a head pose input.

80. The method of claim 77, further comprising determining that the first user focus location corresponds to the first location on a condition that the first user focus location satisfies a proximity criterion relative to the first location.

81. The method of claim 80, further comprising determining that the first user focus location corresponds to the first location on a condition that the first user focus location satisfies the proximity criterion for a threshold duration.

82. The method of claim 77, wherein the second user input comprises a gaze input.

83. The method of claim 77, wherein the second user input comprises a head pose input.

84. The method of claim 77, further comprising determining that the second user focus location corresponds to the second location on a condition that the second user focus location satisfies a proximity criterion relative to the second location.

85. The method of claim 84, further comprising determining that the second user focus location corresponds to the second location on a condition that the second user focus location satisfies the proximity criterion for a threshold duration.

86. The method of claim 77, further comprising displaying a second user interface in response to determining that the first user focus location corresponds to the first location.

87. The method of claim 86, further comprising displaying the second user interface on a condition that the first user input is maintained for a threshold duration.

88. The method of claim 77, further comprising displaying the first user interface on a condition that the first user input is maintained for a threshold duration and the second user focus location corresponds to the second location.

89. The method of claim 77, further comprising displaying an affordance proximate the first location before obtaining the first user input.

90. The method of claim 89, further comprising ceasing to display the affordance after a condition is satisfied.

91. The method of claim 89, further comprising ceasing to display the affordance in response to displaying the first user interface for a threshold duration.

92. The method of claim 89, further comprising ceasing to display the affordance after the first user interface has been displayed a threshold number of times.

93. The method of claim 89, further comprising ceasing to display the affordance in response to detecting the first user input directed to the affordance.

94. The method of claim 77, further comprising changing a visual property of the first user interface in response to detecting a third user input directed to the first user interface.

95. A device comprising:
one or more processors;
a non-transitory memory;
a display;
an input device; and
one or more programs stored in the non-transitory memory, which, when executed by the one or more processors, cause the device to:
obtain a first user input corresponding to a first user focus location;
determine that the first user focus location corresponds to a first location within a field of view;
obtain a second user input corresponding to a second user focus location; and
on a condition that the second user focus location corresponds to a second location different from the first location within the field of view, display a first user interface.

96. A non-transitory memory storing one or more programs, which, when executed by one or more processors of a device, cause the device to:
obtain a first user input corresponding to a first user focus location;
determine that the first user focus location corresponds to a first location within a field of view;
obtain a second user input corresponding to a second user focus location; and
on a condition that the second user focus location corresponds to a second location different from the first location within the field of view, display a first user interface.
